(19) United States
(12) Patent Application Publication
(10) Pub. No.: US 2023/0384609 A1
(43) Pub. Date: Nov. 30, 2023

(54) METHOD AND SYSTEM FOR GENERATION OF A NEEDLE-SHAPED BEAM BY A DIFFRACTIVE OPTICAL ELEMENT FOR USE IN EXTENDED DEPTH-OF-FOCUS OPTICAL COHERENCE TOMOGRAPHY

(71) Applicants: CZ Biohub SF, LLC, San Francisco, CA (US); The Board of Trustees of the Leland Stanford Junior University, Stanford, CA (US)

(72) Inventors: Jingjing Zhao, Stanford, CA (US); Adam de la Zerda, Los Altos, CA (US)

(21) Appl. No.: 18/447,094

(22) Filed: Aug. 9, 2023

Related U.S. Application Data
(63) Continuation of application No. PCT/US2022/018939, filed on Mar. 4, 2022.
(60) Provisional application No. 63/157,575, filed on Mar. 5, 2021.
(60) Provisional application No. 63/216,061, filed on Jun. 29, 2021.

(51) Int. Cl. G02B 27/42; G02B 27/09

(52) U.S. Cl. CPC G02B 27/4227; G02B 27/0944; G01N 21/4795

(57) ABSTRACT

A diffractive optical element includes a substrate including a plurality of unit cells arrayed across the substrate. Each of the unit cells includes M phase elements and each of the M phase elements is characterized by one of a set of N phase values. Each of the set of N phase values is equal to an incremental phase value times an index m, wherein M>1 and m=1 . . . N.

### CROSS-REFERENCE TO RELATED APPLICATIONS

This application is a continuation of International Patent Application No. PCT/US2022/018939, filed Mar. 4, 2022, which claims the benefit of U.S. Provisional Patent Application No. 63/157,575, filed Mar. 5, 2021, and U.S. Provisional Patent Application No. 63/216,061, filed Jun. 29, 2021, the contents of which are hereby incorporated by reference in their entirety for all purposes.

### BACKGROUND OF THE INVENTION

Optical coherence tomography (OCT) is an imaging technique that has been developed and used to capture three-dimensional images of various media, including biological specimens. Some OCT systems utilize near-infrared light for imaging, with the relatively long wavelength of the near-infrared light enabling the light to penetrate into the medium.

Despite the progress that has been made in microscopy and OCT techniques, there exists a need in the art for improved methods and systems for extending the depth of focus in OCT imaging systems.

### SUMMARY OF THE INVENTION

Embodiments of the present invention relate generally to methods and systems for optical systems. In particular, some embodiments relate to methods and systems for generating needle-shaped beams useful in OCT systems. The light beams provided by embodiments of the present invention can also be referred to as axial multi-foci beams. Merely by way of example, a diffractive optical element with a predetermined phase profile is utilized to generate a beam with multiple foci distributed along the axial direction of propagation, providing an illumination beam that is characterized by a large depth of focus and a narrow beam diameter, i.e., a needle-shaped or axial multi-foci beam. The methods and systems described herein can be applied to a variety of optical imaging and analysis systems.

According to an embodiment of the present invention, a diffractive optical element is provided. The diffractive optical element includes a substrate including a plurality of unit cells arrayed across the substrate. Each of the unit cells includes M phase elements and each of the M phase elements is characterized by one of a set of N phase values, wherein each of the set of N phase values is equal to an incremental phase value times an index m, wherein M>1 and m=1 . . . N.

According to another embodiment of the present invention, a method of generating a needle-shaped beam is provided. The method includes providing a diffractive optical element including a plurality of unit cells. Each unit cell of the plurality of unit cells includes a plurality of phase elements and each of the plurality of phase elements is characterized by a different phase value. The method also includes receiving an incident beam of light propagating in an axial direction, directing the incident beam of light to pass through the diffractive optical element, and generating a plurality of foci along the axial direction to form the needle-shaped beam. In some embodiments, the different phase values comprise a set of N phase values and each of the different phase values is equal to an incremental phase value times an index m, wherein m=1 . . . N, for example, the set of N phase values can range between 0 radians and 2π radians, for instance, the incremental phase value can be equal to 2π/N. The method can further include focusing the incident beam of light using a lens after the incident beam of light has passed through the diffractive optical element, or additionally scanning the incident beam of light after the incident beam of light has passed through the diffractive optical element, or alternatively, image relaying the incident beam of light after the incident beam of light has passed through the diffractive optical element. The different phase values corresponding to each of the plurality of phase elements can be distributed differently in at least two of the plurality of unit cells, for example, distributed randomly in the at least two of the plurality of unit cells. The plurality of unit cells can form a two-dimensional array.

According to a specific embodiment of the present invention, a diffractive optical element is provided. The diffractive optical element includes a substrate including a plurality of unit cells arrayed across the substrate. Each of the unit cells includes M phase elements and each of the M phase elements is characterized by one of a set of N phase values, wherein a first number of phase elements characterized by a unique phase value in a first unit cell of the plurality of unit cells is different than a second number of phase elements characterized by the unique phase value in a second unit cell of the plurality of unit cells.

Each unit cell of the plurality of unit cells can include a predetermined number of phase elements characterized by the unique phase value. The predetermined number of phase elements can include a random number. Each of the set of N phase values can be equal to an incremental phase value times an index m, wherein M>1 and m=1 . . . N. The incremental phase value can be equal to 2n/N, for example, 4<M<300 or M>N. The substrate can include fused silica.

According to another specific embodiment of the present invention, a method of designing a diffractive optical element operable to produce a needle-shaped beam is provided. The method includes determining parameters of optical elements in a lens system, determining spatial locations of a plurality of phase elements positioned in a unit cell, wherein each of the plurality of phase elements is associated with one of a set of foci, optimizing axial positions of the foci in the set of foci to generate a predetermined intensity distribution for the needle-shaped beam, and determining an additional phase factor associated with at least one of beam intensity, beam diameter, side lobe ratio, or efficiency of the needle-shaped beam.

The parameters of the optical elements in the lens system can include parameters of an objective lens, a wavelength of an incident light beam, a depth of focus of the needle-shaped beam, a number of the foci in the set of foci, a size of the unit cell, a size of each of the plurality of phase elements, or a refractive index of an imaging space. The unit cell can be one of a plurality of unit cells and the spatial locations of the plurality of phase elements positioned in the unit cell can include one of the plurality of phase elements being positioned at a same location in each unit cell of the plurality of unit cells. The unit cell can be one of a plurality of unit cells and the spatial locations of the plurality of phase elements positioned in the unit cell can include one of the plurality of phase elements being positioned at a different location in each unit cell of the plurality of unit cells. The predetermined intensity distribution can include an intensity distribution as a function of the axial position characterized by uniformity greater than 90%. The predetermined intensity distribution can include an intensity distribution as a function of the axial position characterized by an increase in beam intensity as a function of axial position. Determining the additional phase factor can include adjusting the additional phase factor to modify metrics for at least one of a beam intensity, a beam diameter, a side lobe ratio, or an efficiency of the needle-shaped beam. Determining the additional phase factor can include adjusting a set of additional phase factors, each of the additional phase factors in the set of additional phase factors being associated with one of the set of foci.

According to an alternative embodiment of the present invention, a method of collecting an optical coherence tomography (OCT) image is provided. The method includes generating an incident light beam propagating in an axial direction, directing the incident light beam through a diffractive optical element (DOE) including a plurality of unit cells, wherein each unit cell of the plurality of unit cells includes a plurality of phase elements and each of the plurality of phase elements is characterized by a different phase value, generating a needle-shaped beam including a plurality of foci disposed along the axial direction, performing an A-scan using the needle-shaped beam, and scanning the needle-shaped beam to perform a B-scan.

Performing the B-scan can include scanning the needle-shaped beam in a transverse direction. Performing the B-scan further can include scanning the needle-shaped beam in a lateral direction. The OCT image can include a three-dimensional image. The needle-shaped beam can be characterized by a depth of focus between 4 and 200 Rayleigh lengths. The different phase values can include a set of N phase values and each of the different phase values is equal to an incremental phase value times an index m, wherein m=1 . . . N. The set of N phase values can range between 0 radians and 2π radians. The incremental phase value can be equal to 2π/N. The different phase values can be distributed differently in at least two of the plurality of unit cells, for example, distributed randomly in the at least two of the plurality of unit cells. The plurality of unit cells can form a two-dimensional array. The method can also include focusing the incident light beam after the incident light beam has been directed through the diffractive optical element or image relaying the incident light beam after the incident light beam has been directed through the diffractive optical element.

Numerous benefits are achieved by way of the present invention over conventional techniques. For example, embodiments of the present invention provide the capability to extend the depth-of-focus of the light beam used in an OCT system while maintaining the lateral resolution along the depth of the image.

These and other embodiments of the invention, along with many of its advantages and features, are described in more detail in conjunction with the text below and attached figures.

### BRIEF DESCRIPTION OF THE DRAWINGS

FIG. 1A is a simplified cross-sectional diagram of a lens illustrating phase modulation introduced by a lens.

FIG. 1B is a simplified cross-sectional diagram of a lens and phase plate illustrating phase modulation introduced by the lens in combination with the phase plate according to an embodiment of the present invention.

FIG. 2A is a simplified cross-sectional diagram of a lens system illustrating phase modulation introduced by a phase modulation device in combination with a lens according to an embodiment of the present invention.

FIG. 2B is a plot illustrating beam intensity produced using a lens system shown in FIG. 2A as a function of transverse and axial position according to an embodiment of the present invention.

FIG. 2C is a simplified plan view diagram illustrating phase of a phase modulation device implemented as a diffractive optical element according to an embodiment of the present invention.

FIG. 2D is a simplified plan view diagram illustrating an enlarged portion of the DOE illustrated in FIG. 2C according to an embodiment of the present invention.

FIG. 2E is a photograph of a portion of a lithographically defined DOE according to an embodiment of the present invention.

FIG. 2F is a simplified cross-sectional view diagram illustrating a special case of the lens system shown in FIG. 2A according to an embodiment of the present invention.

FIG. 3A is a simplified plan view diagram illustrating unit cells of the DOE illustrated in FIG. 2C according to an embodiment of the present invention.

FIG. 3B is a plot showing diffraction peaks produced by the unit cells illustrated in FIG. 3A according to an embodiment of the present invention.

FIG. 4A is a simplified plan view diagram illustrating an enlarged portion of another DOE according to an embodiment of the present invention.

FIG. 4B is a simplified plan view diagram illustrating elements having equal focus according to an embodiment of the present invention.

FIG. 4C is a plot showing a diffraction peak produced by the elements having equal focus illustrated in FIG. 4A according to an embodiment of the present invention.

FIG. 5A is a simplified plan view diagram illustrating an enlarged portion of yet another DOE according to an embodiment of the present invention.

FIG. 5B is a simplified plan view diagram illustrating unit cells of the DOE illustrated in FIG. 5A and elements having equal focus according to an embodiment of the present invention.

FIG. 5C is a plot showing a diffraction peak produced by the unit cells and elements having equal focus illustrated in FIG. 5A according to an embodiment of the present invention.

FIG. 6A is a plot of beam intensity in a transverse/axial cross-section produced using a first phase modulation device according to an embodiment of the present invention.

FIG. 6B is a plot of intensity as a function of axial position for the beam shown in FIG. 6A according to an embodiment of the present invention.

FIG. 6C is a plot of initial and optimized axial position of foci as a function of the index number of focus according to an embodiment of the present invention.

FIG. 6D is a plot of beam intensity in a transverse/axial cross-section produced using a second phase modulation device according to an embodiment of the present invention.

FIG. 6E is a plot of intensity as a function of axial position for the beam shown in FIG. 6D according to an embodiment of the present invention.

FIG. 7A is a plot of beam intensity in a transverse/axial cross-section produced using a third phase modulation device according to an embodiment of the present invention.

FIG. 7B is a plot of intensity as a function of axial position for the beam shown in FIG. 7A according to an embodiment of the present invention.

FIG. 8 is a plot illustrating beam intensity in a transverse/lateral cross-section at a specific axial position according to an embodiment of the present invention.

FIG. 9A is a plot illustrating beam diameter as a function of the additional phase factor according to an embodiment of the present invention.

FIG. 9B is a plot illustrating beam intensity as a function of the additional phase factor according to an embodiment of the present invention.

FIG. 9C is a plot illustrating beam efficiency as a function of the additional phase factor according to an embodiment of the present invention.

FIG. 9D is a plot illustrating beam side lobe ratio as a function of the additional phase factor according to an embodiment of the present invention.

FIG. 10A is a simplified flowchart illustrating a method of designing a DOE according to an embodiment of the present invention.

FIG. 10B is a simplified plot of phase difference function as a function of phase element position for the third focus according to an embodiment of the present invention.

FIG. 10C is a simplified plot of the phase wrapped phase difference function as a function of phase element position for the third focus including the additional phase factor according to an embodiment of the present invention.

FIG. 10D is a simplified plot of the phase elements associated with focus f₃, including an inset that shows the phase elements associated with focus f₃ for a small number of phase elements according to an embodiment of the present invention.

FIG. 10E is a simplified plot of the phase difference function as a function of phase element position for the phase elements associated with the third focus according to an embodiment of the present invention.

FIG. 10F is a simplified plot of the phase difference function as a function of phase element position for the phase elements associated with all nine foci according to an embodiment of the present invention.

FIG. 10G is a plot of beam intensity in a transverse/axial cross-section for the needle-shaped beam produced using the DOE including the phase difference function illustrated in FIG. 10F.

FIG. 11A is a plot of initial and optimized axial position of foci as a function of the index number of focus according to an embodiment of the present invention.

FIG. 11B is a plot of beam intensity in a transverse/axial cross-section produced using a first additional phase factor according to an embodiment of the present invention.

FIG. 11C is a plot of beam diameter as a function of axial position for the beam shown in FIG. 11B according to an embodiment of the present invention.

FIG. 11D is a plot of beam intensity in a transverse/axial cross-section produced using a second additional phase factor according to an embodiment of the present invention.

FIG. 11E is a plot of beam diameter as a function of axial position for the beam shown in FIG. 11D according to an embodiment of the present invention.

FIG. 11F is a plot of beam intensity in a transverse/axial cross-section produced using a third additional phase factor according to an embodiment of the present invention.

FIG. 11G is a plot of beam diameter as a function of axial position for the beam shown in FIG. 11F according to an embodiment of the present invention.

FIG. 11H is a plot of beam intensity in a transverse/axial cross-section produced using a fourth additional phase factor according to an embodiment of the present invention.

FIG. 11I is a plot of beam diameter as a function of axial position for the beam shown in FIG. 11H according to an embodiment of the present invention.

FIG. 12A is a simplified cross-sectional view of an OCT with an integrated DOE in the sample arm of the OCT according to an embodiment of the present invention.

FIG. 12B is a simplified cross-sectional view of an OCT with an integrated DOE in the sample arm of the OCT according to another embodiment of the present invention.

FIG. 12C is a simplified cross-sectional view of an OCT with an integrated DOE in the sample arm of the OCT according to yet another embodiment of the present invention.

FIG. 12D is a simplified cross-sectional view of an OCT with an independent light collection channel and an integrated DOE in the sample arm of the OCT according to an embodiment of the present invention.

FIG. 12E is a simplified schematic diagram illustrating elements of a spectral domain OCT system with an integrated DOE according to an embodiment of the present invention.

FIG. 12F is a simplified schematic diagram illustrating elements of an SD-OCT system with an integrated DOE according to another embodiment of the present invention.

FIG. 12G is a simplified flowchart illustrating a method of collecting an optical coherence tomography (OCT) image according to an embodiment of the present invention.

FIG. 13A is a simplified plot illustrating beam intensity as a function of axial position for a Gaussian beam.

FIG. 13B is a plot illustrating beam intensity in a transverse/lateral cross-section at a first axial position for the Gaussian beam.

FIG. 13C is a plot illustrating beam intensity in a transverse/lateral cross-section at a second axial position for the Gaussian beam.

FIG. 13D is a plot illustrating beam intensity in a transverse/lateral cross-section at a third axial position for the Gaussian beam.

FIG. 13E is a simplified plot illustrating beam intensity as a function of axial position for a needle-shaped beam according to an embodiment of the present invention.

FIG. 13F is a plot illustrating beam intensity in a transverse/lateral cross-section at a first axial position for the needle-shaped beam.

FIG. 13G is a plot illustrating beam intensity in a transverse/lateral cross-section at a second axial position for the needle-shaped beam.

FIG. 13H is a plot illustrating beam intensity in a transverse/lateral cross-section at a third axial position for the needle-shaped beam.

FIG. 13I is a plot illustrating beam size and beam intensity as a function of axial position for the Gaussian beam and the needle-shaped beam illustrated in FIGS. 13A and 13E, respectively.

FIG. 14A is an OCT image showing polystyrene beads imaged using a Gaussian beam.

FIG. 14B is an OCT image showing polystyrene beads imaged using a needle-shaped beam according to an embodiment of the present invention.

FIG. 14C is a plot illustrating measured bead diameter as a function of axial position for the measurements using the Gaussian beam and the needle-shaped beam, respectively.

FIG. 15A is an OCT image showing polystyrene beads imaged using a Gaussian beam.

FIG. 15B is an OCT image showing polystyrene beads imaged using a needle-shaped beam according to an embodiment of the present invention.

FIG. 16A is an OCT image showing polystyrene beads imaged using a Gaussian beam.

FIG. 16B is an OCT image showing polystyrene beads imaged using a needle-shaped beam according to an embodiment of the present invention.

FIG. 17A is an OCT image showing a first biological sample imaged using a Gaussian beam.

FIG. 17B is an OCT image showing the first biological sample imaged using the needle-shaped beam according to an embodiment of the present invention.

FIG. 18A is an OCT image showing a second biological sample imaged using a Gaussian beam.

FIG. 18B is an OCT image showing the second biological sample imaged using a needle-shaped beam according to an embodiment of the present invention.

FIG. 19A is an OCT image showing human skin imaged using a Gaussian beam.

FIG. 19B is an OCT image showing the human skin imaged using a needle-shaped beam according to an embodiment of the present invention.

FIG. 20A is a first OCT image showing human skin imaged using a Gaussian beam.

FIG. 20B is a second OCT image showing human skin imaged using a first needle beam according to an embodiment of the present invention.

FIG. 20C is a third OCT image showing human skin imaged using a second needle beam according to an embodiment of the present invention.

FIG. 20D is a fourth OCT image showing human skin imaged using a third needle beam according to an embodiment of the present invention.

FIG. 20E is a fifth OCT image showing human skin imaged using a fourth needle beam according to an embodiment of the present invention.

FIG. 21A is a plot of beam intensity in a transverse/axial cross-section produced using an alternative DOE and a first additional phase factor according to an embodiment of the present invention.

FIG. 21B is a plot illustrating beam intensity in a transverse/lateral cross-section at a specific axial position for the plot of beam intensity in FIG. 21A according to an embodiment of the present invention.

FIG. 21C is a plot of beam intensity in a transverse/axial cross-section produced using an alternative DOE and a second additional phase factor according to an embodiment of the present invention.

FIG. 21D is a plot illustrating beam intensity in a transverse/lateral cross-section at a specific axial position for the plot of beam intensity in FIG. 21C according to an embodiment of the present invention.

FIG. 21E is a plot of beam intensity as a function of axial position for the beam shown in FIG. 21C according to an embodiment of the present invention.

FIG. 22A is a plot of beam intensity in a transverse/axial cross-section produced using another alternative DOE according to an embodiment of the present invention.

FIG. 22B is a plot of beam intensity as a function of axial position for the beam shown in FIG. 22A according to an embodiment of the present invention.

FIG. 23A is a plot of beam intensity in a transverse/axial cross-section produced using yet another alternative DOE according to an embodiment of the present invention.

FIG. 23B is a plot of beam intensity as a function of axial position for the beam shown in FIG. 23A according to an embodiment of the present invention.

### DETAILED DESCRIPTION OF SPECIFIC EMBODIMENTS

Embodiments of the present invention relate generally to methods and systems for optical systems. In particular, some embodiments relate to methods and systems for generating needle-shaped beams useful in OCT systems. Merely by way of example, a diffractive optical element with a predetermined phase profile is utilized to generate a beam with multiple foci distributed along the axial direction of propagation, providing an illumination beam that is characterized by a large depth of focus and a narrow beam diameter, i.e., a needle-shaped beam. The methods and systems described herein can be applied to a variety of optical imaging and analysis systems.

As discussed above, there exists a need in the art for improved methods and systems for extending the depth of focus in OCT imaging systems. For example, spectral domain OCT (SD-OCT) is an interferometric technique that provides depth-resolved sample structure information encoded in the magnitude and the delay of the back-scattered light by analyzing the interference fringe pattern of the spectrum. SD-OCT does not rely on a mechanical depth scan to acquire the depth-resolved sample structure information, thus its lateral or transversal resolution is determined by the diameter of the focused illumination beam, which is not constant along the depth direction.

As described herein, embodiments of the present invention utilize an optical device (e.g., an optical element) with a predetermined phase modulation pattern to generate a plurality of foci positioned along an axial direction. This plurality of foci form a needle-shaped beam that can be used as a illumination beam in an OCT system, thereby providing an OCT system with enhanced depth of focus in comparison to conventional systems. In some embodiments, a diffractive optical element (DOE) is utilized as the optical element with a predetermined phase modulation pattern, but embodiments of the present invention are not limited to this particular implantation. In other embodiments, a variety of optical devices can be utilized to perform phase modulation, including a binary optical element (BOE), a spatial light modulator (SLM), a digital mirror device (DMD), a metalens, combinations thereof, or the like. Moreover, although some embodiments are described in relation to use in an OCT system, the needle-shaped beam can be utilized in other optical applications that benefit from a beam with a substantially uniform transverse and lateral profile as a function of axial position. As examples, the needle-shaped beam provided by embodiments of the present invention could be useful in a variety of applications, including optical coherence tomography, light-sheet microscopy, confocal microscopy, two-photon, three photon, or multi-photon microscopy, photoacoustic tomography, laser radar, and the like. One of ordinary skill in the art would recognize many variations, modifications, and alternatives.

Although some conventional systems use multiple beams, an annular phase mask, or a Bessel beam to extend the depth of focus in OCT systems, each of these conventional methods have drawbacks. These drawbacks include low depth of focus gain, low efficiency in producing light in a useful beam profile, fluctuations in the uniformity of the beam in the axial direction, and complicated system architectures. Accordingly, embodiments of the present invention provide an extended depth of focus beam for use in OCT systems and other optical systems that is characterized by a large depth of focus, a narrow beam diameter, high efficiency, the suppression of side lobes, uniform axial intensity, and compatibility with conventional OCT systems.

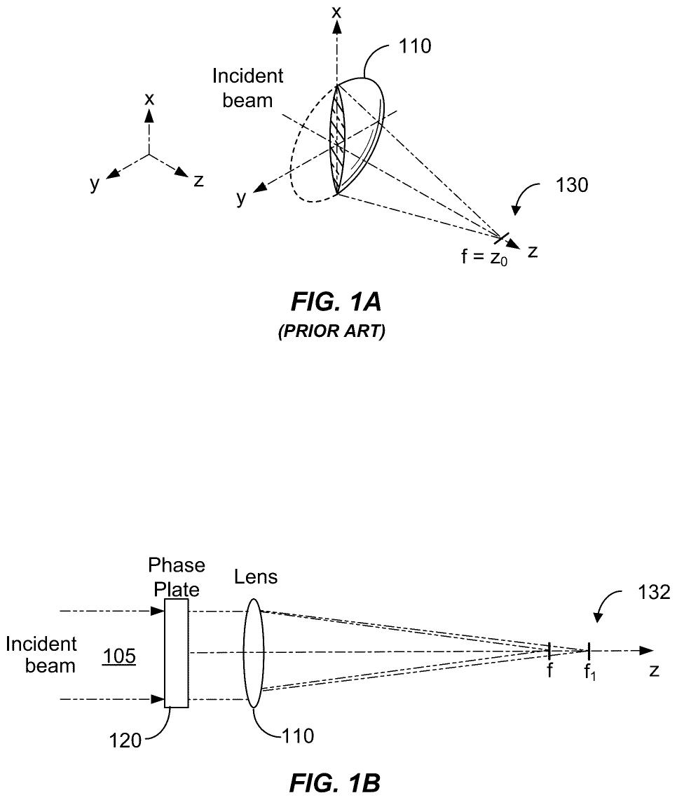

FIG. 1A is a simplified cross-sectional diagram of a lens illustrating phase modulation introduced by a lens. As illustrated in FIG. 1A, lens 110, also referred to as an objective or objective lens, introduces phase modulation P_{Obj}(x,y,f), where (x,y) are the coordinates in the transverse and lateral directions, respectively, at the lens surface, and f is the focal length of lens 110. Herein, the axes lying in the plane of the optical elements are the x-axis (i.e., the transverse axis) and the y-axis (i.e., the lateral axis) and the beam propagation is along the axial direction (i.e., along the z-axis). As will be described, the needle-shaped beam produced and utilized by embodiments of the present invention can be characterized by the beam diameter measured in the transverse and lateral directions and by the beam intensity and depth of focus measured in the axial direction aligned with the direction of propagation of the needle-shaped beam.

As illustrated in FIG. 1A, an incident beam is focused by lens 110 located at z-axis position z=0 so that the incident beam converges to focal point 130 at a distance z₀ along the z-axis. The phase modulation introduced by lens 110 can be computed as:

$${P}_{Obj} ( x , y , f ) = - \frac{2 π n}{λ} \frac{{x}^{2} + {y}^{2}}{f} \qquad ( 1 )$$

where n is the index of refraction of the imaging space (i.e., the space through which the beam travels), λ is the wavelength of the incident beam, x and y are coordinates in the transverse/lateral plane, respectively, and f is the focal length of the lens. Accordingly, lens 110 converts a planar wavefront, for example, of a Gaussian beam, to a spherical wavefront, resulting in focusing of incident light at focal point 130.

Referring to FIG. 1A, the z=0 position is located at the origin of the x-y-z coordinate system. Herein, z₀ is defined as the location at which a Gaussian beam would be focused by lens 110. In FIG. 1A, a Gaussian beam would be focused by lens 110 at z=f=z₀. As will be described more fully below, embodiments of the present invention utilize phase modulation devices to extend the depth of focus from the location z=f=z₀ to form an extended depth of focus that extends from z₀ to axial locations z>z₀, for example from z₀ to z₀+1000 μm. In other embodiments, the depth of focus can be extended to values that are less than z₀, for example, the extended depth of focus could extend from z₀-1000 μm to z₀+500 μm.

FIG. 1B is a simplified cross-sectional diagram of a lens and phase plate illustrating phase modulation introduced by the lens in combination with the phase plate according to an embodiment of the present invention. Referring to FIG. 1B, phase plate 120, with a phase modulation P_{PM} is positioned adjacent lens 110 such that the phase plate receives incident light and introduces the desired phase modulate prior to focusing by lens 110. The phase plate 120 introduces phase modulation P_{PM} equal to the difference in the phase modulations associated with two objective lenses having focal lengths of f₁ and f:

P_{PM}(x,y,f,f₁)=P_{Obj}(x,y,f₁)−P_{Obj}(x,y,f) (2)

As a result, the combination of phase plate 120 and lens 110 results in incident beam 105 being focused at a new focal point 132 located at position f₁ along the z-axis. Accordingly, insertion of phase plate 120 with phase modulation P_{PM} shifts the focal point from f to f₁. As a result, the combination of phase plate 120 and lens 110 is equivalent to a lens having a phase modulation of P_{Obj}(x,y,f₁).

The phase difference function FS between two lenses can be defined as:

FS(x,y,f,f₁)=P_{Obj}(x,y,f₁)−P_{Obj}(x,y,f) (3)

This phase difference function represents the phase difference between two lenses whose focal lengths are f₁ and f, respectively. Accordingly, the phase difference function associated with phase plate 120 can be represented by:

FS(x,y,f,f₁)=P_{Obj}(x,y,f₁)−P_{Obj}(x,y,f) (4)

As described more fully below, this phase difference function, which in combination with an objective lens, shifts the focus along the axial direction, is varied in the transverse/lateral plane (i.e., the x-y plane) by embodiments of the present invention. As a result, considering different positions in the transverse/lateral plane, light incident on the positions assigned to the first focus in the transverse/lateral plane will experience phase difference values associated with the first focus, resulting in light incident at these positions assigned to the first focus being focused at a first focal point, whereas light incident on positions assigned to the second focus in the transverse/lateral plane will experience phase difference values associated with the second focus, resulting in light incident at these positions assigned to the second focus being focused at a second focal point. Accordingly, a number of foci are created as a result of the variation in the phase difference function in the transverse/lateral plane. It should be noted that a single position cannot focus the light rays incident on the single position or change the direction of light incident on the single position.

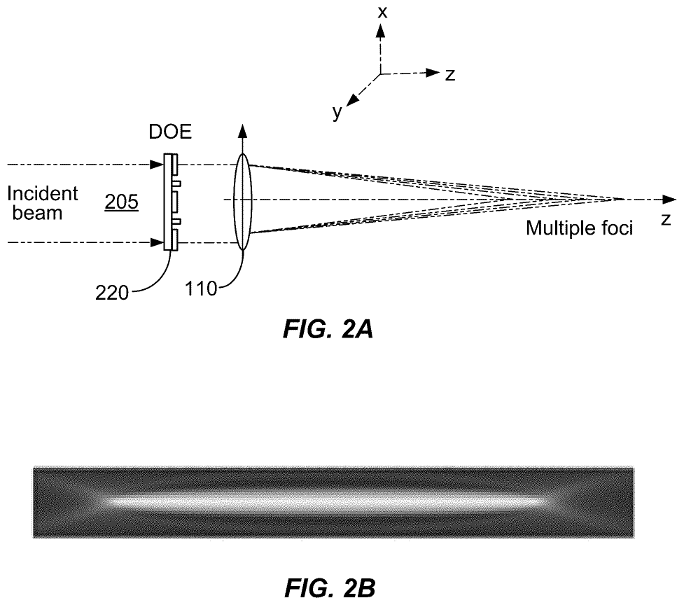

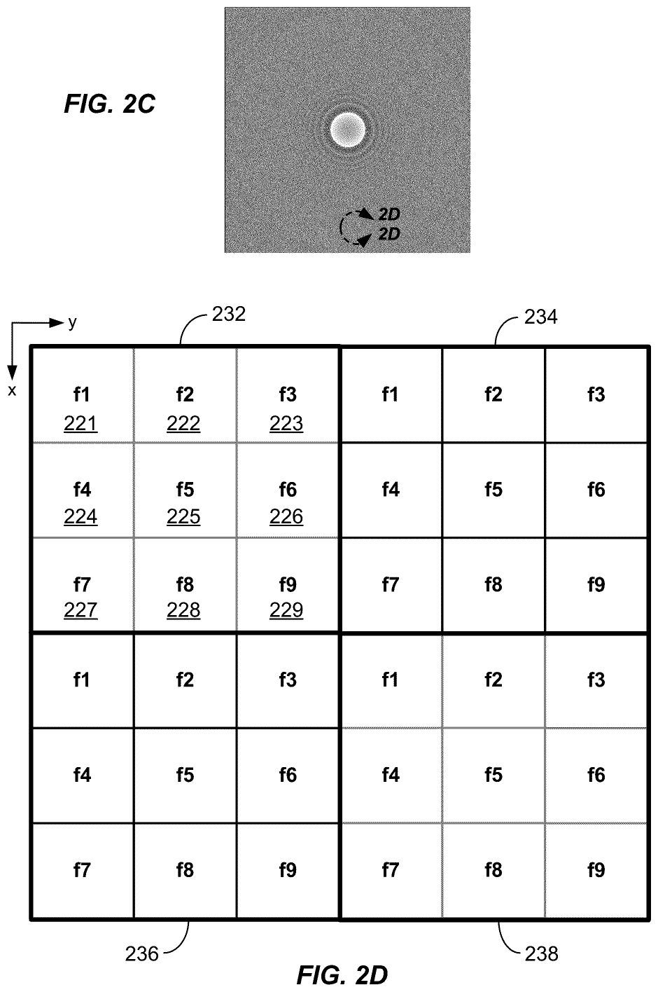

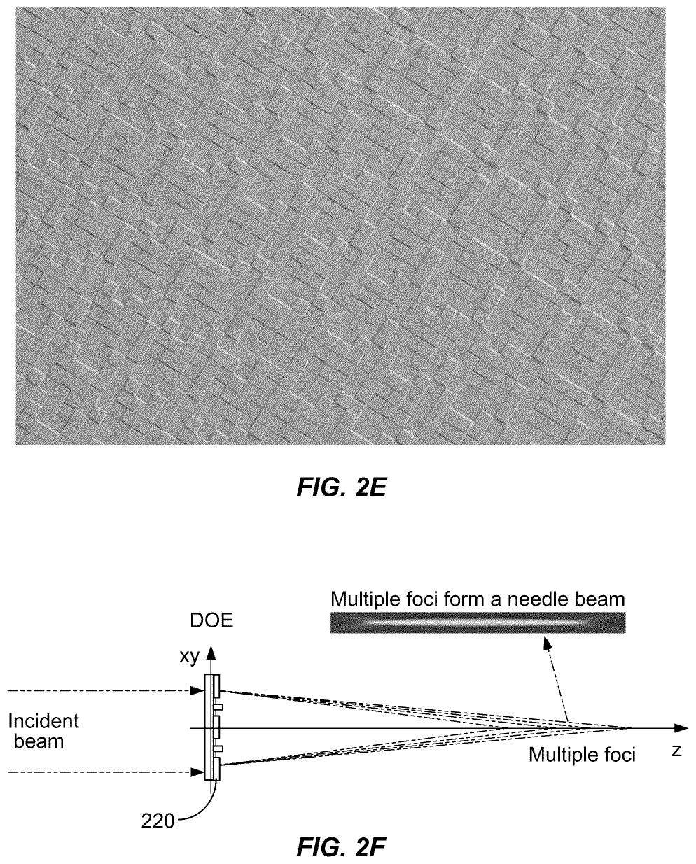

FIG. 2A is a simplified cross-sectional diagram of a lens system illustrating phase modulation introduced by a phase modulation device in combination with a lens according to an embodiment of the present invention. As illustrated in FIG. 2A, the phase modulation device is implemented as a diffractive optical element (DOE) 220 that is characterized by various thicknesses as a function of the transverse and lateral dimensions. In this cross-sectional view, only the variation in thickness as a function of transverse dimension is illustrated, but it will be appreciated that the variation in thickness is present in the lateral dimension as well. Although thickness variation is used to introduce variation in phase modulation as a function of transverse/lateral position in this embodiment, it will be appreciated that other techniques to introduce variation in phase modulation can be utilized, including differing material composition as a function of position, or the like.

As discussed above, although a phase modulation device implemented in the form of a DOE is illustrated in FIG. 2A, this is not required by the present invention and other devices operable to introduce differing phase modulation as a function of transverse and lateral dimensions can be utilized within the scope of the embodiments of the present invention described herein. For example, in addition to DOEs, other optical devices including BOEs, SLMs, DMDs, metalenses, combinations thereof, or the like can be utilized.

Referring to FIG. 2A, DOE 220, which contains different phase difference functions at various transverse/lateral positions, and lens 110 are used in combination to focus incident beam 205 at multiple foci. In other words, the phase pattern associated with DOE 220 contains multiple phase difference functions FS(x,y,f,fₘ), generating multiple foci along the optical axis, which aligns with the axial direction (i.e., the z-axis). As described herein, the multiple foci will form a needle-shaped beam.

The function of the phase pattern associated with DOE 220 can be written as:

$${P}_{DOE} ( x , y , f , {f}_{1} , ... , {f}_{M} ) = {\sum }_{m = 1}^{M} \{ [ FS ( x , y , f , {f}_{m} ) + {Ap}_{m} ] \cdot {Loc}_{m} ( x , y ) \} \qquad ( 5 )$$

where M is the total number of the foci, m is the index number of focus (i.e., one focal point), Locₘ(x,y) is the location function, and Apₘ is an additional phase factor to adjust the needle-beam intensity, diameter, side lobe ratio, and efficiency.

The location function Locₘ(x,y) is used to identify the phase difference function associated with each position or location in the transverse/lateral plane. The value of Locₘ(x,y) is either 1 or 0 to identify whether the particular location (x,y) is assigned to the phase difference function FS(x,y,f,fₘ), resulting in light passing through the particular location to focus at fₘ, i.e., Locₘ(x,y)=1, or is not assigned to the phase difference function FS(x,y,f,fₘ), i.e., Locₘ(x,y)=0. Thus, location function Locₘ(x,y) effectively serves as a mask with a value of 1 for portions of the x-y plane at which the phase difference function is equal to FS(x,y,f,fₘ) and a value of 0 in the other portions.

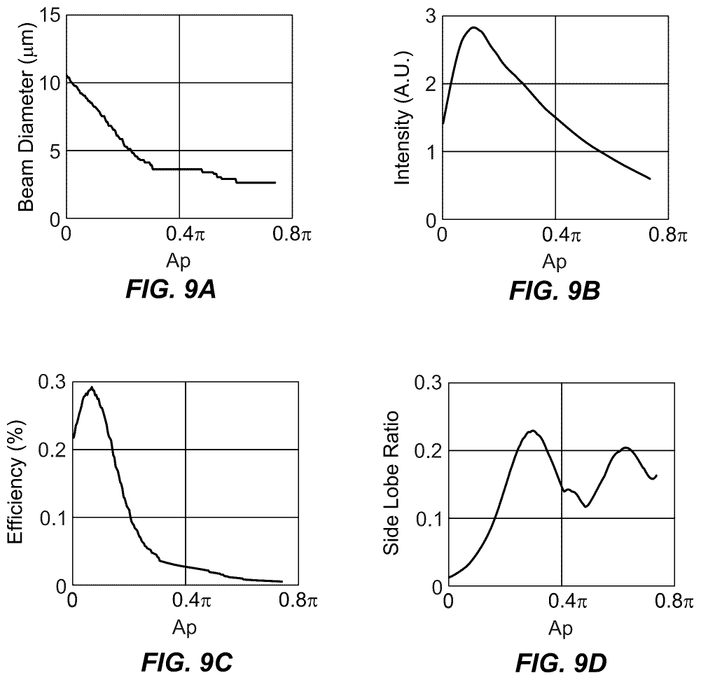

The additional phase factor Apₘ is described more fully below in relation to FIGS. 9A-9D. In a particular embodiment, the additional phase factor is defined as Apₘ=−Ap×(m−1), where Ap is a constant value and m is the index number of each focus. In other embodiments, the additional phase factor can be defined using other values determined via optimization methods. Referring to equation (5), the additional phase factor is added to the phase difference function for each focus, thereby impacting the needle-shaped beam parameters.

As described more fully below, optimizations of f₁, . . . , f_{M}, Locₘ(x,y), and Apₘ are utilized to achieve desired beam parameters and improve the performance of systems utilizing the needle-beam provided by embodiments of the present invention.

FIG. 2B is a plot illustrating beam intensity produced using lens system shown in FIG. 2A as a function of transverse and axial position according to an embodiment of the present invention. As illustrated in FIG. 2B, the multiple foci produced using the combination of DOE 220 and lens 110 results in a beam intensity that, rather than increasing to a focal point as the beam converges and then decreasing as the beam diverges away from the focal point, is characterized by a substantially uniform beam intensity and beam diameter as a function of axial position. Thus, a needle-shaped beam is formed with narrow and uniform diameter and extended and uniform intensity. Although the substantially uniform beam diameter in the transverse direction is illustrated in FIG. 2B, it will be appreciated that the beam diameter in the lateral direction (i.e., the y-axis) will also be substantially uniform.

FIG. 2C is a simplified plan view diagram illustrating phase of a phase modulation device implemented as a diffractive optical element according to an embodiment of the present invention. The phase modulation illustrated in FIG. 2C can be the phase modulation associated with DOE 220, providing a phase difference ranging from 0 radians to 2π radians.

FIG. 2D is a simplified plan view diagram illustrating an enlarged portion of the DOE illustrated in FIG. 2C according to an embodiment of the present invention. In the enlarged portion shown in FIG. 2D, nine different values of phase modulation are illustrated. Phase elements 221, 222, 223, 224, 225, 226, 227, 228, and 229 have corresponding phase modulations of f1, f2, f3, f4, f5, f6, f7, f8, and f9, where fₘ=FS(x,y,f,fₘ)·Locₘ(x,y). In some embodiments, the phase elements can be referred to as pixels to denote that they operate independently. In this embodiment, four unit cells 232, 234, 236, and 238 are illustrated, with each of the unit cells including the nine phase elements discussed in relation to unit cell 232. Thus, in this embodiment, a periodic DOE is illustrated, with each unit cell repeating on centers separated by the transverse size of three phase elements in the transverse direction (i.e., the x-direction) and the lateral size of three phase elements in the lateral direction (i.e., the y-direction). As will be described more fully below, this particular periodic DOE is merely exemplary and other spatial distributions of the phase elements are included within the scope of the embodiments described herein.

Referring to FIG. 2D, if the location of the top left phase element 221 in unit cell 232 is defined in the transverse and lateral directions as (x₁,y₁), then this top left phase element 221 has a phase difference function of FS(x₁,y₁,f₁,f). Accordingly, in combination with lens 110, light incident on the positions assigned to the first focus (e.g., phase element 221) in the transverse/lateral plane will experience phase difference values associated with the first focus, resulting in light incident on these positions being focused at a distance f₁ from lens 110. Similarly, light incident on the positions assigned to the other focus distances in the transverse/lateral plane will experience phase difference values associated with the other focus distances, resulting in light incident on these positions being focused at distances f₂ through f₉, thereby resulting in the generation of nine foci along the axial direction. It should be noted that a single position cannot focus the light rays incident on the single position or change the direction of light incident on the single position, however, the overall effect of the phase elements associated to each of the foci can result in multiple foci. As described more fully below, embodiments of the present invention are not limited to the use of nine foci and a larger number of foci or a smaller number of foci can be utilized depending on the particular application. One of ordinary skill in the art would recognize many variations, modifications, and alternatives.

Each phase element introduces a predetermined incremental phase equal to the phase difference function. In one implementation, the thickness of each phase element is equal to an incremental thickness times an index. In the DOE illustrated in FIG. 2D, with nine phase elements, the incremental phase difference introduced by each phase element can be 2π/16=0.393π . . . 0125π. As described above, each of the phase elements provides nine different values of phase modulation that result in the generation of nine foci. If the phase elements are each assigned a different incremental phase, nine of the 16 incremental phases will be utilized, with the other seven incremental phases not being utilized.

Although 16 values of incremental phases are illustrated in this example, other values are included within the scope of the present invention, as illustrated by the various embodiments described herein, including 2, 4, 8, 32, 64, 128, 256, 512 or greater than 512 values of incremental phase. In other embodiments, the number of phase elements varies, for example, 16 phase elements using a 4×4 unit cell, 25 phase elements using a 5×5 unit cell, or the like. In an embodiment that utilizes a 4×4 unit cell, 16 values of incremental phase can be utilized. As an example, in one 2×2 unit cell, the values without quantization could be 0, 0.01π, 0.5π, and 1π. After 16-level quantization, these values will be 0.125π, 0.125π, 0.5π, and 1π (i.e., 1×0.125π, 1×0.125π, 4×0.125π, and 8×0.125π).

Another example for a 5×5 unit cell without quantization is:

| | | | | |
|---|---|---|---|---|
| [1.0340 | 3.8449 | 3.9179 | 4.6728 | 2.9501 |
| 1.6570 | 4.6824 | 1.6755 | 0 | 6.0947 |
| 0.9611 | 1.6755 | 2.1424 | 3.8682 | 3.5071 |
| 3.4234 | 3.8624 | 3.3284 | 2.3898 | 1.2069 |
| 1.4057 | 1.6051 | 1.7277 | 5.8103 | 0.8292]. |

After 16-level quantization, these values will be:

| | | | | |
|---|---|---|---|---|
| [3 | 10 | 10 | 12 | 8 |
| 4 | 12 | 4 | 16 | 16 |
| 2 | 4 | 5 | 10 | 9 |
| 9 | 10 | 8 | 6 | 3 |
| 4 | 4 | 4 | 15 | 2] * 0.125 π. |

The relationship between the phase modulation P(x,y) and the height H(x,y) of the phase element is P(x,y)=2π·(n_{DOE}|1)·H(x,y)/λ′, where n_{DOE} is the refractive index of the DOE material and λ′ is the wavelength in vacuum. Thus, for a DOE fabricated in fused silica with an index of refraction of n_{DOE}=1.452 and an incident light wavelength of 910 nm, the incremental thickness would be 126 nm.

FIG. 2E is a photograph of a portion of a lithographically defined DOE according to an embodiment of the present invention. This lithographically defined DOE achieves the phase pattern associated with the phase elements by forming a relief surface with different height levels as described above. In the photograph shown in FIG. 2E, the phase element (i.e., the pixel) size is 10 μm square.

The lithographically defined DOE illustrated in FIG. 2E was fabricated on a transparent, fused silica wafer as a 1024×1024 array of phase elements, each measuring 10 μm×10 μm in the transverse and lateral directions, resulting in a DOE with dimensions of 10.24 mm×10.24 mm. In order to fabricate the design illustrated in FIG. 2E, four lithographic masks were used, each patterning one or more of the phase elements prior to etching a predetermined multiple of an incremental thickness of material from the silica wafer, resulting in each of the phase elements having a predetermined height. In one implementation, the incremental thickness of material that was removed from the silica wafer was 126 nm. As a result, 16 heights for the phase elements are available for use, i.e., 16 heights equal to 126 nm×[1, 2, 3, 4, 5, 6, 7, 8, 9, 10, 11, 12, 13, 14, 15, 16]. Accordingly, at a wavelength of 910 nm and for the refractive index of fused silica (n_{DOE}=1.452), phase modulation in 16 steps from 0.125π radians to 2π radians is achieved. As will be evident to one of skill in the art, the number of heights is not limited to 16 and a greater number or a lesser number can be utilized to obtain a larger number of foci or a reduced number of foci. Moreover, although some embodiments are described in terms of a single wavelength of incident light (e.g., 910 nm), this is not required and other wavelengths, particularly, illumination sources including a range of wavelengths (e.g., 800 nm-1 μm), can be utilized according to embodiments of the present invention since the difference in thickness between different portions of the phase modulation device is small enough to not adversely impact system performance. Accordingly, both narrow band and broadband applications are suitable using embodiments of the present invention.

FIG. 2F is a simplified cross-sectional view diagram illustrating a special case of the lens system shown in FIG. 2A according to an embodiment of the present invention. In this special case, the focal length f is infinitely long. Namely, there is no lens used in conjunction with the DOE 220 and the phase difference function is FS(x,y,f→∞,fₘ)=P_{Obj}(x,y,fₘ). As illustrated in equation (1), the phase function is a function of not only f, but also x and y. Accordingly, the phase function for the DOE can be different for different x, y positions, effectively integrating a lensing property into the design of the DOE. Consequently, using only the phase pattern P(x,y,f→∞,f₁, . . . , fₘ), embodiments of the present invention can produce multiple foci along the axial direction. Thus, for this special case,

$${P}_{DOE} ( x , y , f \to ∞ , {f}_{1} , ... , {f}_{M} ) = {\sum }_{m = 1}^{M} \{ [ FS ( x , y , f \to ∞ , {f}_{m} ) + {Ap}_{m} ] \cdot {Loc}_{m} ( x , y ) \} \qquad ( 6 )$$

According to some embodiments, the lens phase function can be modeled using several conditions. First, for low numerical aperture lenses, the paraxial approximation can be used since it is appropriate for low numerical aperture lenses. Accordingly, the phase modulation introduced by a low numerical aperture lens can be computed as:

$${P}_{lens} ( x , y , f ) = - \frac{2 π}{{λ}^{′}} n \frac{{x}^{2} + {y}^{2}}{2 f} \qquad ( 7 )$$

where λ′ is the wavelength of the incident light in vacuum and n is the refractive index of the imaging medium.

Moreover, for high numerical aperture lenses, the Abbe sine condition can be utilized. Given this condition, the phase modulation introduced by a high numerical aperture lens can be computed as:

$${P}_{lens} ( x , y , f ) = - \frac{2 π}{{λ}^{′}} n [ \sqrt{{f}^{2} - ( {x}^{2} + {y}^{2} )} - f ] \qquad ( 8 )$$

Finally, the curvature imparted by a perfect lens to generate a spherical wave can be represented by:

$${Φ}_{obj} = - \frac{2 π}{{λ}^{′}} n [ \sqrt{{f}^{2} + ( {x}^{2} + {y}^{2} )} - f ] \qquad ( 9 )$$

Since the phase modulation devices provided by and utilized in embodiments of the present invention generate multiple foci, multiple phase difference functions are implemented in one phase modulation device. For each specific focus fₘ, of the f_{M} focuses, the location function Locₘ(x,y) describes where the FS(x,y,f,fₘ) is spatially located in the phase modulation device. As discussed above, the value of Locₘ(x,y) is either 1 or 0 to identify whether the particular location (x,y) is assigned to the focus fₘ, i.e., Locₘ(x,y)=1 or is not assigned to the focus fₘ, i.e., Locₘ(x,y)=0.

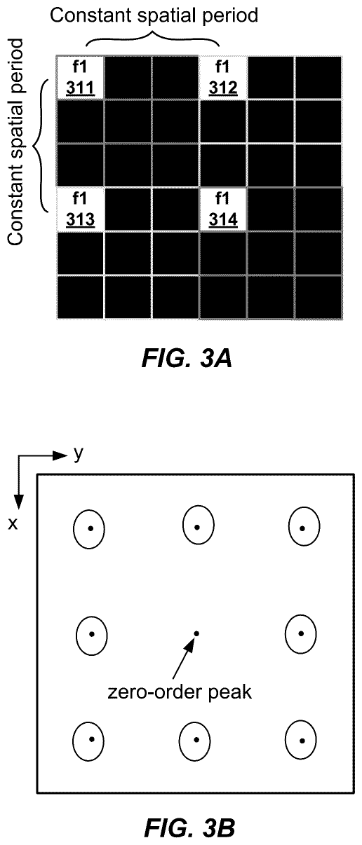

In order to illustrate several different types of location functions, three exemplary location functions are illustrated in FIGS. 3A, 4A, and 5A.

FIG. 3A is a simplified plan view diagram illustrating unit cells of the DOE illustrated in FIG. 2C according to an embodiment of the present invention. As discussed in relation to FIG. 2D, nine different phase values are utilized. Phase elements 311, 312, 313, and 314 have corresponding phase modulations of f₁. These phase elements 311, 312, 313, and 314 are located in the top left corner of four 3×3 unit cells. The unit cells are arrayed in the transverse/lateral plane to form a two-dimensional array. In some embodiments, the two-dimensional array formed by the unit cells is a rectangular array with N×N phase elements. Thus, according to some embodiments, the unit cells are distributed in the transverse/lateral plane in a periodic manner that repeats with distances measured in the transverse/lateral plane.

It will be appreciated that one phase modulation device can include a large number of phase elements, for example, 1024×1024 phase elements. Within the phase modulation device, a plurality of unit cells are arrayed, with each unit cell containing an N×N array of phase elements. In the example, illustrated in FIG. 3A, N=3, providing nine phase elements. In order to produce N×N foci, each phase element in the unit cell is assigned to one focus. Thus, in this example, nine foci are achieved by using nine phase elements in a 3×3 unit cell. It should be noted that a unit cell could have less than N×N foci, for example, a 5×5 unit cell could utilize only 5 foci, with 5 of the 25 phase elements assigned one of the five foci, another 5 of the 25 phase elements assigned one of the other five foci, etc.

In the embodiment illustrated in FIG. 3A, the locations of phase elements having a specific focus (e.g., f₁) in different unit cells are constant. Thus, in FIG. 3A, the phase elements in the top left corner of each unit cell has the same focus (i.e., f₁). An advantage provided by this particular location function is that the energy of incident light beam can be distributed uniformly over the different foci, because the area of one unit cell is relatively small in comparison to the whole phase modulation device. Moreover, due to the small size of the unit cells in comparison to the whole phase modulation device, the light intensity incident on a unit cell is spatially uniform over the unit cell. This spatial uniformity is beneficial since the incident light beam is usually not spatially uniform, for example, a Gaussian beam.

Although not illustrated in FIG. 3A, the locations of other phase elements having other specific foci (e.g., f₂, f₃, etc.) in different unit cells will also be constant in this implementation. Accordingly, as shown in FIG. 2D, phase elements with a second focus (i.e., f₂) will be positioned in the top middle of each unit cell and phase elements with a third focus (i.e., f₃) will be positioned in the top right of each unit cell. One of ordinary skill in the art would recognize many variations, modifications, and alternatives.

FIG. 3B is a plot showing diffraction peaks produced by the unit cells illustrated in FIG. 3A according to an embodiment of the present invention. Since the distribution of a specific focus (e.g., f₁) is regular over the whole phase modulation device, the periodic distribution of common phase elements will introduce high-order diffraction peaks, which can be considered as a source of noise. Referring to FIG. 3B, in image space, a zero-order peak is illustrated as well as eight higher-order diffraction peaks annotated with circles.

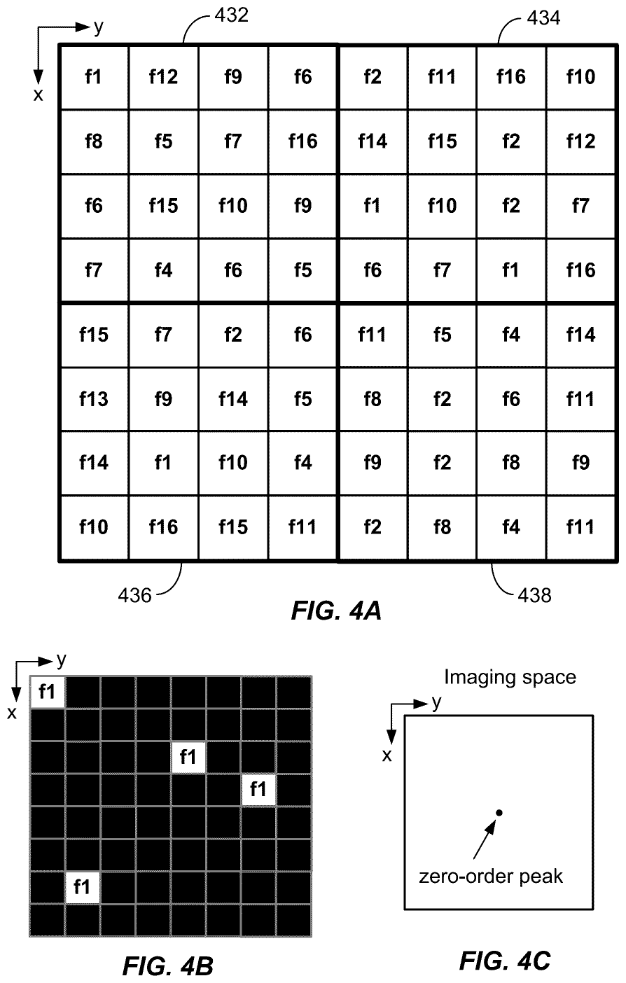

FIG. 4A is a simplified plan view diagram illustrating an enlarged portion of another DOE according to an embodiment of the present invention. In this embodiment, in order to generate M=16 foci, phase elements of the phase modulation device with each predetermined incremental phase are randomly distributed across the phase modulation device, resulting in the 16 phase elements in each unit cell 432, 434, 436, and 438 being randomly assigned to one of the 16 foci. In this example, 16 values of incremental phase are utilized along with 16 phase elements per unit cell, resulting in the generation of 16 foci. In some embodiments, the number of phase elements assigned to each focus is controllable, with the predetermined number of phase elements randomly distributed across the phase modulation device. Thus, by utilizing an equal number of phase elements associated with each phase modulation value, the energy of the incident light beam can be distributed uniformly or substantially uniformly across the phase modulation device while still providing for a random distribution of the phase elements associated with each modulation value. Depending on the particular implementation, the energy of the incident light beam may not be as uniform as that provided by other embodiments.

FIG. 4B is a simplified plan view diagram illustrating elements having equal phase and focus according to an embodiment of the present invention. As illustrated in FIG. 4B, the location of phase elements having a specific incremental phase and a specific focus (e.g., f₁) are randomly distributed across the phase modulation device, with potentially differing numbers of phase elements having the specific focus in different unit cells. For unit cells 432 and 436, one phase element in each of the unit cells has the specific focus (i.e., f₁), whereas in unit cell 434, two phase elements have the specific focus s (i.e., f₁), and unit cell 438 has zero phase elements having the specific focus (i.e., f₁). The location function Loc₁(x,y) for the specific focus f₁, for this example, is Loc₁(x,y)=1 for the four phase elements indicated by the specific focus f₁ and is Loc₁(x,y)=0 for the remaining phase elements. The unit cells are arrayed in the transverse/lateral plane to form a two-dimensional array. In some embodiments, the two-dimensional array formed by the unit cells is a rectangular array with N×N phase elements.

FIG. 4C is a plot showing diffraction peaks produced by the elements having equal focus illustrated in FIG. 4A, according to an embodiment of the present invention. Because of the random distribution of each focus across the phase modulation device, the higher-order diffraction peaks shown in FIG. 3B will be reduced or eliminated. FIG. 4C illustrates the lack of higher-order peaks resulting from diffraction through a phase modulation device with locations of phase elements having a specific focus randomly distributed across the phase modulation device. It should be noted that if the incident light beam is non-uniform or the optical calibration is not accurate, the energy assigned to each focus will generally differ from the value utilized in the DOE design. Similar effects can be observed when the incident light beam is not centered on the optical axis or the DOE has spatial non-uniformities in index of refraction of thickness.

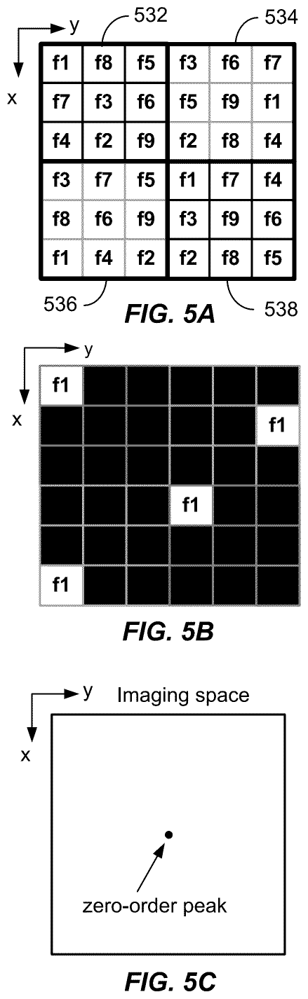

FIG. 5A is a simplified plan view diagram illustrating an enlarged portion of yet another DOE according to an embodiment of the present invention. In the DOE illustrated in FIG. 5A, the phase modulation device includes a plurality of 3×3 unit cells in a manner similar to the DOEs discussed in relation to FIGS. 3A and 4A. However, in this embodiment, each of the 3×3 phase elements making up the unit cell is randomly distributed within the unit cell. Referring to FIG. 5A, unit cell 532 includes all nine foci f₁, f₂, f₃, f₄, f₅, f₆, f₇, f₈, and f₉, with each of the foci positioned randomly within the unit cell. Accordingly, the locations of a specific focus in different unit cells are random.

FIG. 5B is a simplified plan view diagram illustrating unit cells of the DOE illustrated in FIG. 5A and elements having equal focus according to an embodiment of the present invention. In this particular implementation, focus f₁ is positioned in the top left of unit cell 532, in the right middle of unit cell 534, in the bottom left of unit cell 536, and in the top left of unit cell 538. Similar random distributions characterize the other eight foci. The unit cells are arrayed in the transverse/lateral plane to form a two-dimensional array. In some embodiments, the two-dimensional array formed by the unit cells is a rectangular array with N×N phase elements.

FIG. 5C is a plot showing diffraction peaks produced by the unit cells and elements having equal focus illustrated in FIG. 5A, according to an embodiment of the present invention. As illustrated in FIG. 5C, higher-order diffraction peaks are reduced or eliminated in a manner similar to that shown in FIG. 4C since the phase elements associated with each phase modulation value do not have a periodic relationship to each other. Additionally, since the phase modulation device includes an equal number of each of the different phase elements in each unit cell, and therefore, across the phase modulation device, the energy of incident light beam can be distributed uniformly over the different foci.

For many OCT applications, a uniform axial intensity distribution (i.e., along the axial direction aligned with the direction of propagation) of the needle-shaped beam is provided by embodiments of the present invention. The inventors have determined that optimization of the axial position of each of the foci can be utilized to increase the uniformity of the axial intensity distribution.

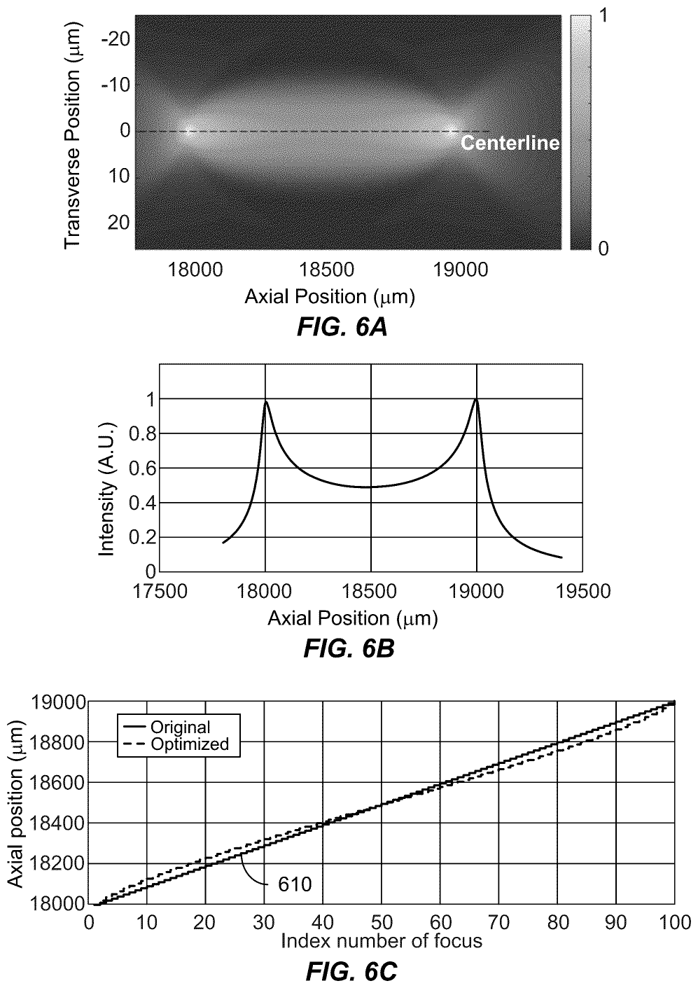

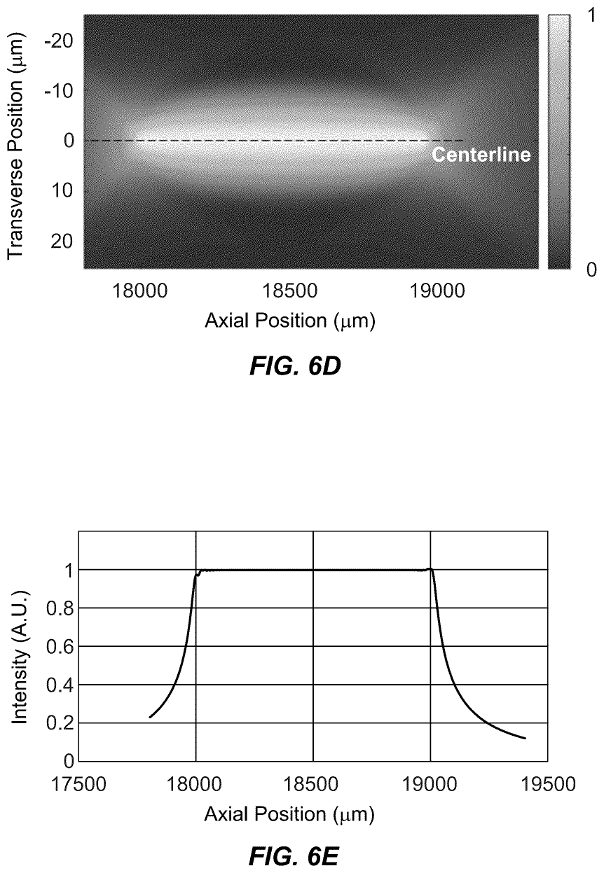

FIG. 6A is a plot of beam intensity in a transverse/axial cross-section produced using a first phase modulation device according to an embodiment of the present invention. In order to produce the beam intensity profile illustrated in FIG. 6A, a DOE was utilized in combination with a lens having an objective focal length of 18 mm. The DOE included a plurality of 10×10 unit cells, with each unit cell having a random distribution of 100 phase elements similar to the DOE illustrated in FIG. 5A. The interval between adjacent foci was set at 10 μm and was constant across all 100 foci. The additional phase factor Apₘ was set to zero, the wavelength of the incident radiation was 910 nm, the imaging space was in air, and the diameter of the incident light beam was 4.6 mm. As shown in FIG. 6A, the resulting needle-shaped beam was ˜1000 μm in length.

FIG. 6B is a plot of intensity as a function of axial position for the beam shown in FIG. 6A according to an embodiment of the present invention. The intensity was measured along the axial direction (i.e., z-axis). With the parameters discussed above and the interval between adjacent foci fixed at 10 μm, the axial intensities at the two ends of the needle-shaped beam are stronger than the axial intensity at the middle of the needle-shaped beam.

FIG. 6C is a plot of initial and optimized axial position of foci as a function of the index number of focus according to an embodiment of the present invention. Referring to FIG. 6C, initially, as discussed in relation to FIGS. 6A and 6B, the interval between each adjacent foci of the 100 foci was fixed at 10 μm. Accordingly, line 610 corresponding to the initial axial locations of the foci is linear, increasing by 10 μm as the index number of focus increases.

The axial locations of the foci were optimized to achieve a uniform intensity as a function of axial position. As shown in FIG. 6C, this resulted in foci with index numbers of ˜1-25 and ˜75-100 being increased to values greater than 10 μm and foci with other index numbers (i.e., ˜26-74) being decreased to values less than 10 μm.

FIG. 6D is a plot of beam intensity in a transverse/axial cross-section produced using a second phase modulation device according to an embodiment of the present invention. FIG. 6E is a plot of intensity as a function of axial position for the beam shown in FIG. 6D according to an embodiment of the present invention. For this second phase modulation device, which utilizes the axial locations of the foci shown in FIG. 6C, the axial beam intensity is uniform as illustrated in FIG. 6E. Thus, after optimizing the axial positions of the foci, the axial beam intensity is uniform.

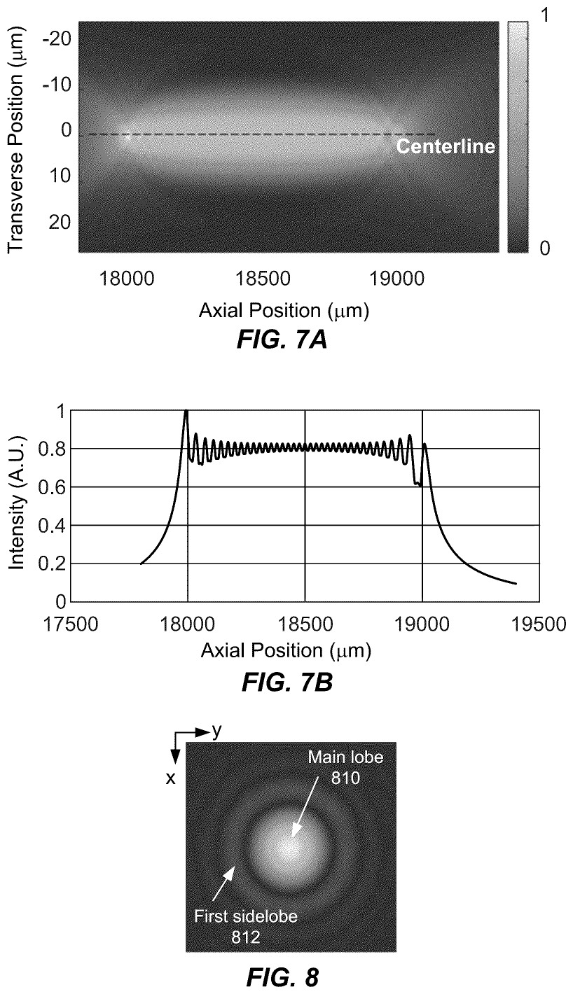

FIG. 7A is a plot of beam intensity in a transverse/axial cross-section produced using a third phase modulation device according to an embodiment of the present invention. FIG. 7B is a plot of intensity as a function of axial position for the beam shown in FIG. 7A according to an embodiment of the present invention.

The inventors have determined that, in general, the average interval between two adjacent foci should be less than 1.5 Rayleigh lengths of the original lens. If the average interval is too large, for example, 2 Rayleigh lengths, the axial intensity will show some fluctuations. An example of these fluctuations is shown in FIG. 7B. For this example, the number of foci is 36 and the other conditions discussed in relation to FIG. 6A were utilized.

FIG. 8 is a plot illustrating beam intensity in a transverse/lateral cross-section at a specific axial position according to an embodiment of the present invention. As illustrated in FIG. 8, the cross-section of the needle-shaped beam indicates that the needle-shaped beam contains a main lobe 810 at the center of the beam and one or more side lobes 812 surrounding the main lobe.

In the embodiments described herein, the following optical parameters are utilized to characterize the needle-shaped beam. The intensity of the needle-shaped beam, referred to as the beam intensity, is defined as the beam intensity at the center of the main lobe. The beam diameter is defined as the full-width-half-maximum (FWHM) of the main lobe. In other embodiments, the beam diameter is defined as diameter at which the beam intensity is the 1/e² intensity. The side lobe ratio is equal to the ratio of the first side lobe intensity to the main lobe intensity. The beam efficiency is defined as the energy ratio of the main lobe energy to the total input energy.

The additional phase factor Apₘ in equation (5) is used in some embodiments, to adjust the beam intensity, the beam diameter, the side lobe ratio, and the efficiency of the needle-shaped beam.

In order to study the impact of the additional phase factor on the beam intensity, the beam diameter, the side lobe ratio, and the beam efficiency, a study was performed in which the focal length of the objective was 18 mm, 5×5 foci were generated using a phase modulation device in which the phase elements were patterned with optimized axial positions, the wavelength of the incident light beam was 910 nm, the imaging space was in air, and the diameter of the incident light beam was 4.6 mm, resulting in a needle-shaped beam 500 μm in length.

In this embodiment, the additional phase factor was set to be Apₘ=−Ap×(m−1), where Ap is a constant value and m is the index number of each focus. If Ap changes from 0 to 0.75π, this results in changes in the beam intensity, the beam diameter, the amount of intensity in the side lobes, and the efficiency of the needle-shaped beam, as shown in FIGS. 9A-9D.

FIG. 9A is a plot illustrating beam diameter as a function of the additional phase factor according to an embodiment of the present invention. FIG. 9B is a plot illustrating beam intensity as a function of the additional phase factor according to an embodiment of the present invention. FIG. 9C is a plot illustrating beam efficiency as a function of the additional phase factor according to an embodiment of the present invention. FIG. 9D is a plot illustrating beam side lobe ratio as a function of the additional phase factor according to an embodiment of the present invention.

Referring to FIGS. 9A-9D, generally, with increasing Ap, the beam diameter decreases to improve the lateral resolution limit of the beam, the beam intensity and efficiency will first increase then decrease, and the side lobe ratio will first increase then show some pseudo-periodic fluctuations. The efficiency is not only affected by the additional phase factor but also optical elements in the system. As an example, the efficiency can be roughly linear with respect to 1/(BL/RL)², where BL is the length of the needle-shaped beam and RL is the Rayleigh length of the objective. The data illustrated in FIGS. 9A-9D was obtained using a phase modulation device in which the difference in the additional phase factor between two adjacent foci was fixed, but the difference in additional phase factor between two adjacent foci can also be varied in other embodiments.

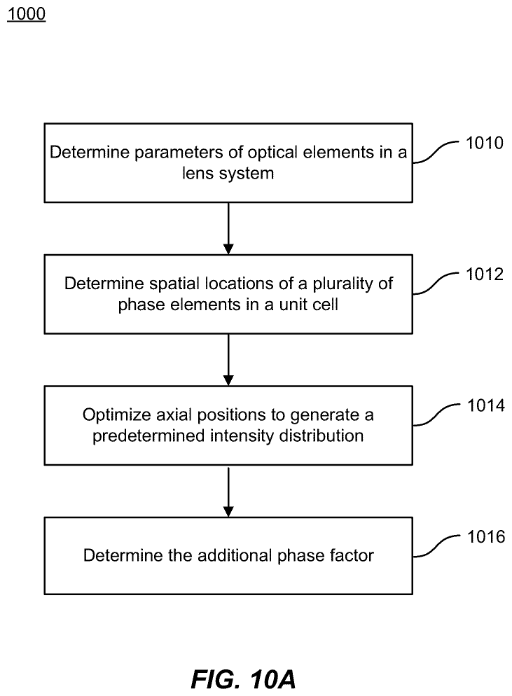

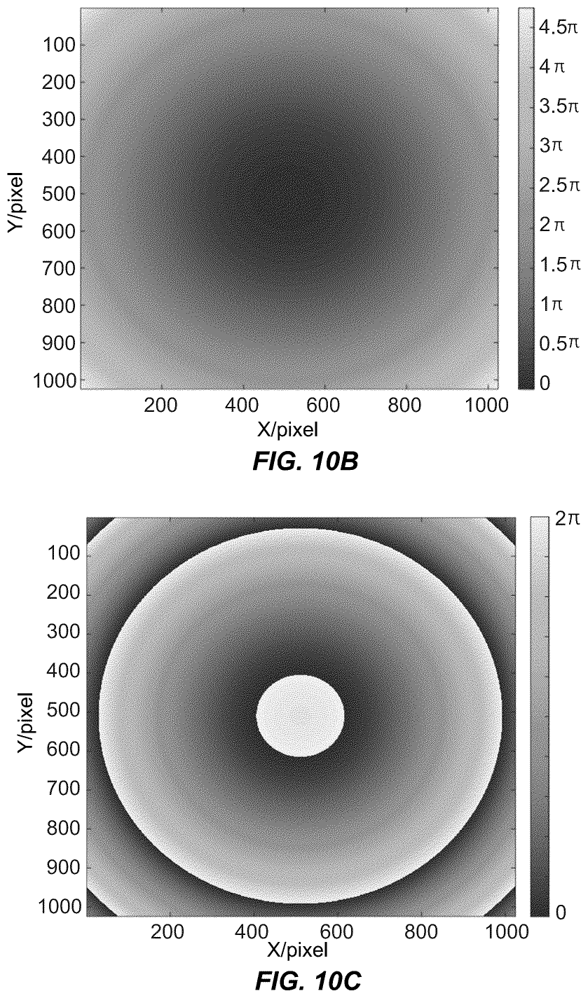

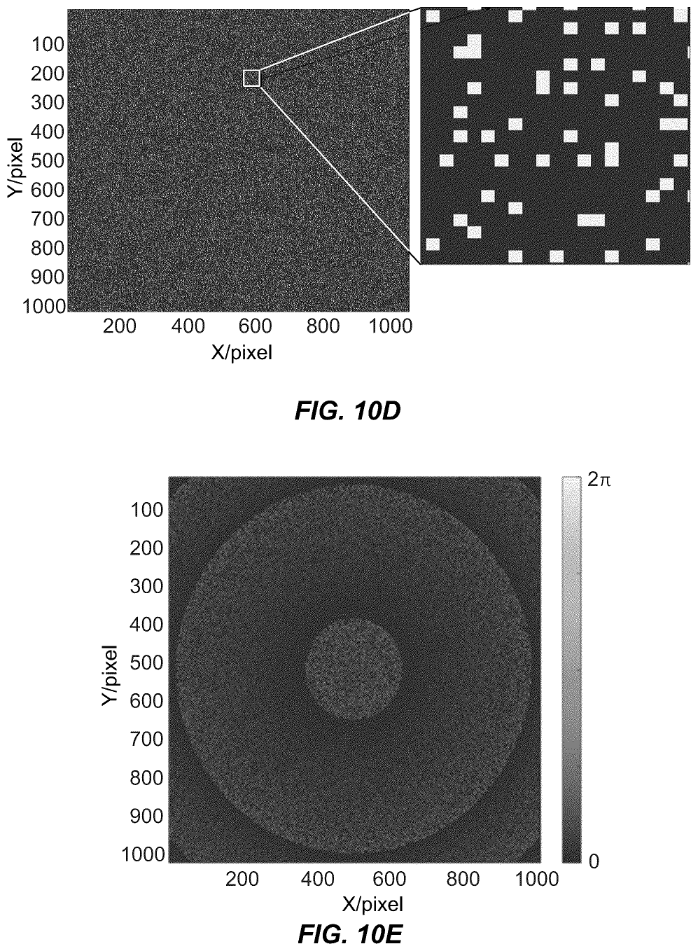

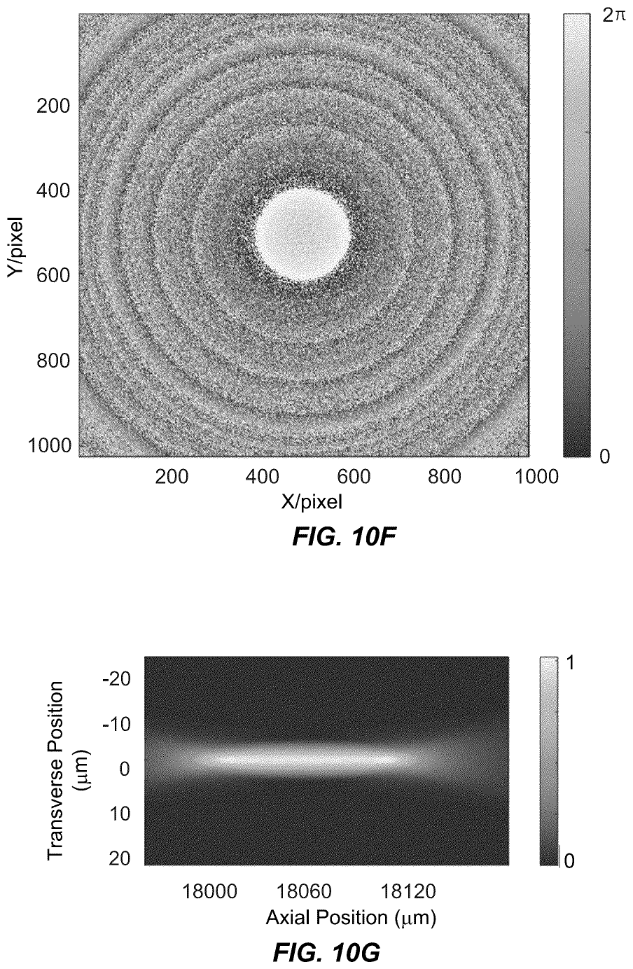

FIG. 10A is a simplified flowchart illustrating a method of designing a DOE according to an embodiment of the present invention. Referring to FIG. 10A, the method 1000 includes determining the parameters of the optical elements in the lens system (1010). These parameters can include the parameters of the objective lens, also referred to as a lens or an objective, including the focal length of the objective lens, the wavelength of the incident light beam, the length of the needle-shaped beam, the number of foci, the size of phase pattern implemented in the DOE, the phase element size in the phase pattern, the refractive index of the imaging space, and the like.

The method also includes determining the spatial locations of each focus in the phase pattern (1012). As discussed in relation to FIGS. 3A, 4A, and 5A, a variety of different spatial distributions can be used in relation to the locations of the phase elements of the phase modulation device. Each of the M phase elements can be distributed in the same location in each unit cell as shown in FIG. 3A, each of the phase elements can be randomly distributed across the entire phase modulation device as shown in FIG. 4A, or each of the phase elements making up the unit cell can be randomly distributed within the unit cell as shown in FIG. 5A.

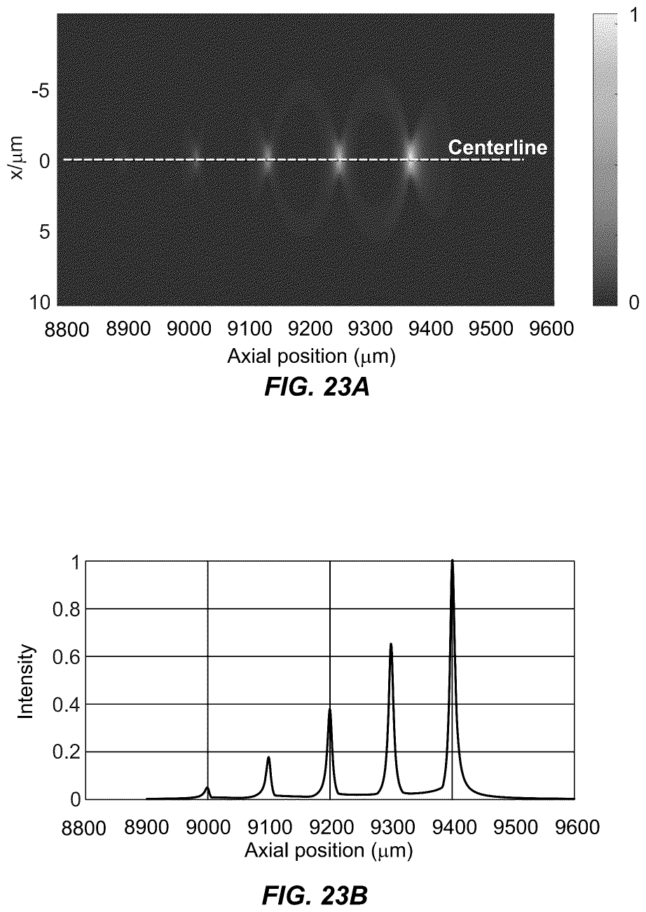

The method further includes optimizing the axial positions of the foci to generate a predetermined intensity distribution (1014). In a particular embodiment, the axial positions of the foci are optimized to generate a uniform intensity distribution as a function of the axial position. As discussed in relation to FIGS. 6C-6E, starting with an initial interval between each adjacent foci, the axial locations of the foci can be optimized to achieve, for example, a uniform beam intensity as a function of axial position. FIGS. 23A and 23B illustrate a multifocal beam with increasing intensity as a function of axial position rather than a uniform intensity distribution.

In some embodiments, the initial interval is fixed (e.g., at 10 μm), providing for a constant distance along the axial direction between each of the foci. In other embodiments, the initial interval can vary over a range (e.g., a random value between 5 μm and 20 μm). Thus, various techniques can be utilized to define the initial distribution of the different foci along the axial direction and the distance between each of the different foci. One of ordinary skill in the art would recognize many variations, modifications, and alternatives.

Additionally, the method includes determining the additional phase factor associated with at least one of the beam intensity, the beam diameter, the side lobe ratio, or the efficiency of the needle-shaped beam (1016). In some embodiments, the additional phase factor is adjusted to achieve desired metrics for each of the beam intensity, the beam diameter, the side lobe ratio, and the efficiency of the needle-shaped beam. Generally, achieving uniform beam intensity as a function of axial position is the metric given highest weight in the optical design. In order to obtain the desired imaging resolution, the beam diameter is usually the metric given the second highest weight in the optical design. The efficiency and side lobe ratio are usually optimized after the beam diameter is defined.

It should be appreciated that the specific steps illustrated in FIG. 10A provide a particular method of designing a DOE according to an embodiment of the present invention. Other sequences of steps may also be performed according to alternative embodiments. For example, alternative embodiments of the present invention may perform the steps outlined above in a different order. Moreover, the individual steps illustrated in FIG. 10A may include multiple sub-steps that may be performed in various sequences as appropriate to the individual step. Furthermore, additional steps may be added or removed depending on the particular applications. One of ordinary skill in the art would recognize many variations, modifications, and alternatives.

As an example of the method illustrated in FIG. 10A, the following DOE was implemented. For this example, the focal length of the objective lens is 18 mm (i.e., f=18 mm), 9 foci are generated by the phase pattern with optimized axial positions of f₁=18 mm+0.0 μm, f₂=18 mm+9.6 μm, f₃=18 mm+27.0 μm, f₄=18 mm+44.1 μm, f₅=18 mm+61.2 μm, f₆=18 mm+78.2 μM, f₇=18 mm+95.0 μm, f₈=18 mm+114.7 μm, and f₉=18 mm+120.0 μm. The needle-shaped beam is 120 μm in axial length, the wavelength is 910 nm, the imaging space is in air, and the diameter of the incident light beam is 4.6 mm.

In this example, the phase pattern size is 10.24 mm×10.24 mm and its phase element size is 10 μm×10 μm, providing a 1024×1024 phase pattern. The locations of each focus in the phase pattern as listed above were generated, as illustrated in FIG. 5A, with a random distribution of the 9 phase elements making up the unit cell within the unit cell.

In order to determine the phase profile for the DOE:

$$P ( x , y , f , {f}_{1} , ... , {f}_{9} ) = {\sum }_{m = 1}^{9} \{ [ FS ( x , y , f , {f}_{m} ) + {Ap}_{m} ] \cdot {Loc}_{m} ( x , y ) \} \qquad ( 10 )$$

the following procedure was utilized.

Considering just the third foci f₃ as an example, the phase difference function is: FS(x,y,f=18 mm, f₃=18.027 mm).

FIG. 10B is a simplified plot of phase difference function as a function of phase element position for the third focus according to an embodiment of the present invention. As illustrated in FIG. 10B, the phase difference is characterized by an increasing phase that starts at the center of the DOE at zero and increases with distance from the center of the DOE, reaching a maximum value of ˜4.7π at the edges of the DOE. The other foci would have similar phase difference functions.

An additional phase factor Apₘ is added to each of the foci in accordance with equation (10). In this example, the additional phase factor is Apₘ=−0.05π×(m−1). For m=3, the additional phase factor Apₘ=−0.1π. This additional phase factor, which is constant as a function of phase element position, is added to the phase difference function illustrated in FIG. 10B, resulting in a phase difference function similar to that illustrated in FIG. 10B, but with each phase element shifted in phase by −0.1π.

In order to represent the phase of each of the phase elements in the range from zero to 2π, the phase difference function including the additional phase factor was processed to wrap the angle in radians to [0-2π]. FIG. 10C is a simplified plot of the phase wrapped phase difference function as a function of phase element position for the third focus including the additional phase factor according to an embodiment of the present invention.

For purposes of DOE fabrication, quantization into 16 levels is applied to the phase difference function in order to provide incremental phase differences that have a step size of 2π/16. The plot of the quantized phase difference function is similar to that shown in FIG. but including quantization.

The location function is then determined for the DOE. In this example, the distribution of phase elements associated with each of the foci (e.g., focus f₃), is random within each unit cell. FIG. 10D is a simplified plot of the phase elements associated with focus f₃, including an inset that shows the phase elements associated with focus f₃ for a small number of phase elements according to an embodiment of the present invention. In FIG. bright pixels are used to indicate the phase elements associated with focus f₃. As illustrated, the distribution of phase elements associated with focus f₃ is random within each unit cell. Similar distributions are determined for each of the other foci.

FIG. 10E is a simplified plot of the phase difference function as a function of phase element position for the phase elements associated with the third focus according to an embodiment of the present invention. The plot in FIG. 10E corresponds to the phase difference function [FS(x,y,f,f₃)+Ap₃]·Loc₃(x,y).

Similar procedures are used to determine the phase elements for the other foci, thereby providing phase difference functions for each of the phase elements in the DOE. In assembling these phase difference functions, wrapping of the angle in radians to the range [0-2π] and quantization into 16 levels is utilized, providing phase difference function for each of the m foci: [FS(x,y,f,fₘ)+Apₘ]·Locₘ(x,y).

FIG. 10F is a simplified plot of the phase difference function as a function of phase element position for the phase elements associated with all nine foci according to an embodiment of the present invention. FIG. 10G is a plot of beam intensity in a transverse/axial cross-section for the needle-shaped beam produced using the DOE including the phase difference function illustrated in FIG. 10F. As illustrated in FIG. 10G, a needle-shaped beam with a depth of focus of 120 μm is provided using the DOE based on the phase difference function determined using FIG. 10A as illustrated in FIG. 10F.

It will be noted that the order of steps illustrated in FIGS. 10B-10F differed from that illustrated in FIG. 10A. As will be evident to one of skill in the art, the steps outlined above may be performed in different orders. As an example, the phase difference function can be determined and phase wrapping and quantization can be performed prior to determination of the location function. Thus, embodiments of the present invention can be performed in various orders as appropriate to the particular application.

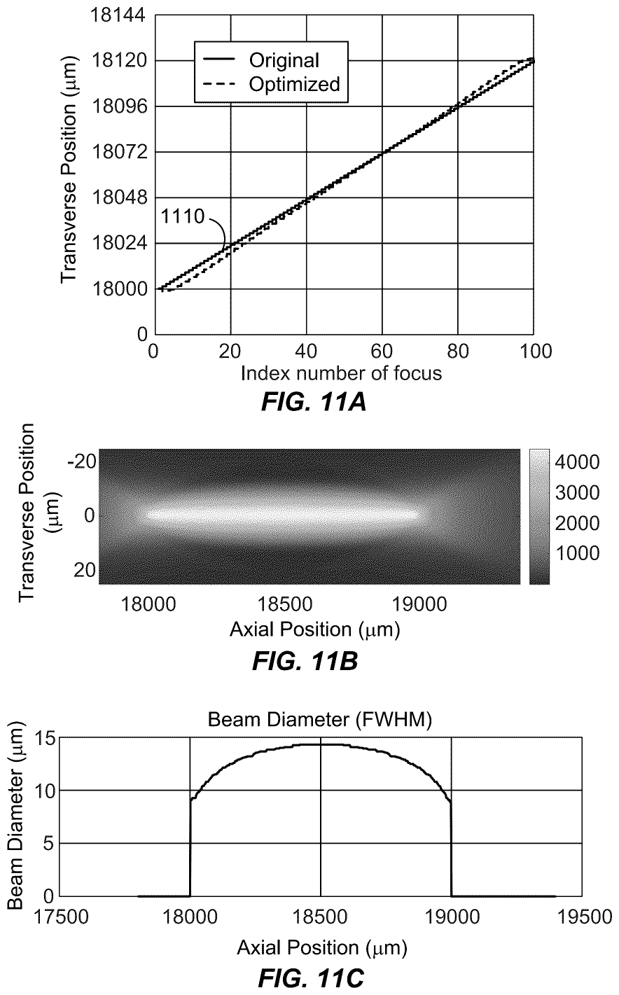

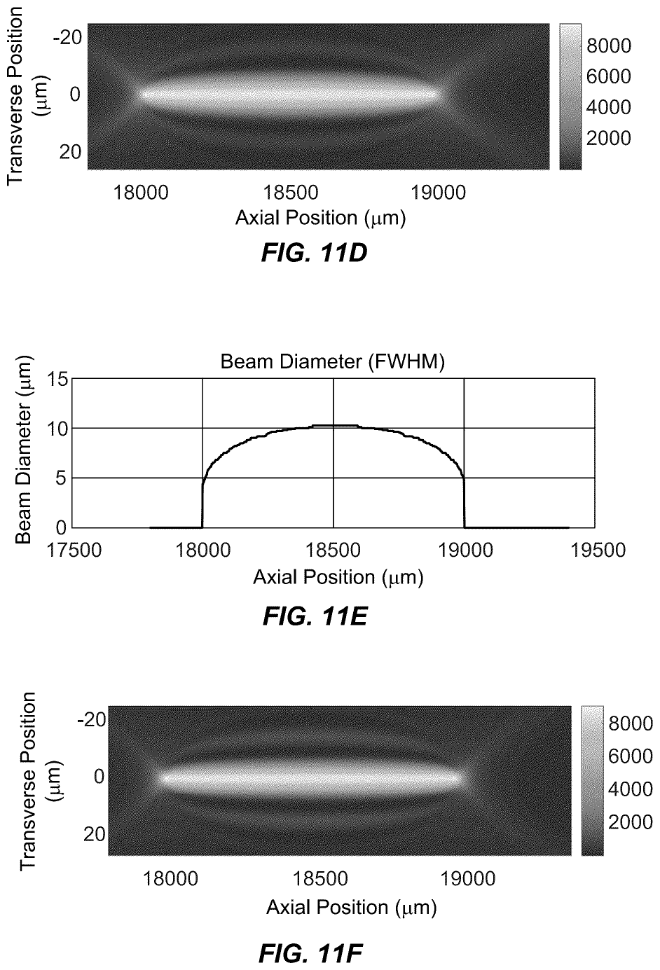

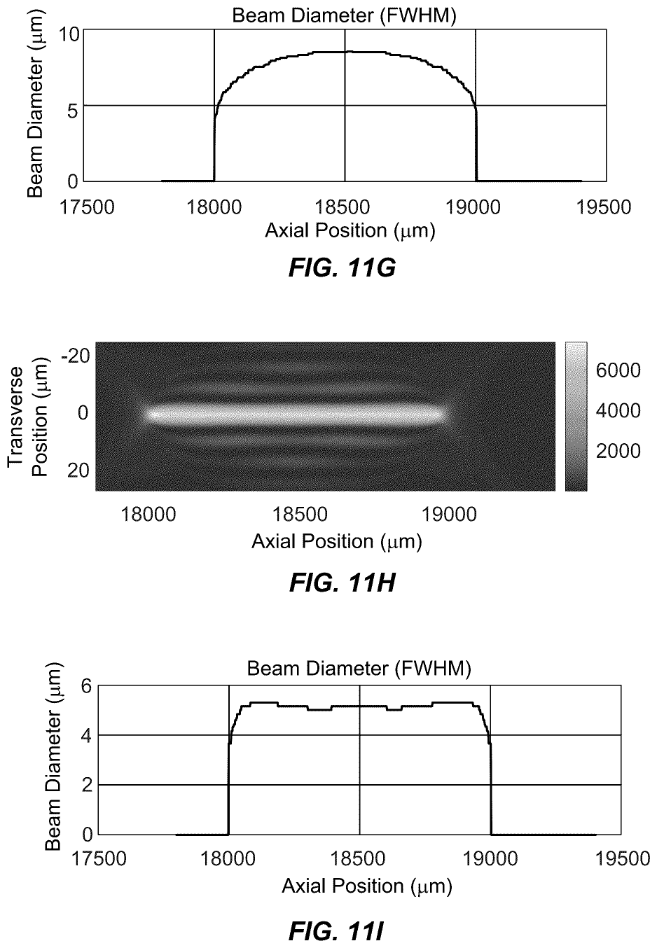

FIG. 11A is a plot of initial and optimized axial position of foci as a function of the index number of focus according to an embodiment of the present invention. As illustrated in FIG. 11A, the initial interval between each adjacent foci of the 100 foci was fixed at 10 μm. Accordingly, line 1110, which corresponds to the initial axial locations of the foci is linear, increasing by 10 μm as the index number of focus increases.

The axial locations of the foci were optimized to achieve a uniform intensity as a function of axial position. As shown in FIG. 11A, this resulted in foci with index numbers of ˜1-25 and ˜75-100 being increased to values greater than 10 μm and foci with other index numbers (i.e., ˜26-74) being decreased to values less than 10 μm.

In order to demonstrate the adjustments to beam intensity, beam diameter, side lobe ratio, and efficiency available using embodiments of the present invention, several values for the additional phase factor were selected as shown in Table 1, resulting in data related to beam intensity and beam diameter as shown in FIGS. 11B-11I. In Table 1, m is an index number of each focus.

The conditions for determining the values shown in Table 1 were: Step 1: the objective focal length is 18 mm, 10×10 foci are generated by the phase pattern with optimized axial positions, the needle-shaped beam is 1000 μm in length, the wavelength is 910 nm, the imaging space is in air, the diameter of the input beam is 4.6 mm, the phase pattern size is 10.24 mm×10.24 mm and the phase element (i.e., pixel) size is 10 nm×10 μm. Step 2: the location of each focus at the phase pattern are generated according to the location function illustrated in FIG. 5A, every unit cell is composed of 10×10 elements, and each element in one unit cell is assigned to one focus.

TABLE 1

| | Beam | Beam | Side | |
|---|---|---|---|---|
| | Intensity | Diameter | Lobe | |
| Additional Phase Factor | (A.U.) | (μm) | Ratio | Efficiency |
| Apₘ = 0 × (m − 1) | 4400 | 8~14 | 1.4% | 12% |
| Apₘ = −0.032π × (m − 1) | 9000 | 4.5~10.5 | 7% | 13% |
| Apₘ = −0.044π × (m − 1) | 8500 | 4~8.5 | 12% | 9% |
| Apₘ = −0.1π × (m − 1) | 6700 | 4~5.5 | 15% | 2.4% |

In other embodiments, the additional phase factor associated with each focus could be optimized independently. In these embodiments, rather than incrementing the additional phase factor for each focus by multiplying by the index m, the additional phase factor for each focus could be optimized to provide additional phase factors for each focus that are independent of the additional phase factors associated with the other foci. One of ordinary skill in the art would recognize many variations, modifications, and alternatives.

Row 1 of Table 1 illustrates beam intensity, beam diameter, side lobe ratio, and efficiency for an additional phase factor of zero (i.e., a first additional phase factor equal to zero). Row 2 of Table 1 illustrates beam intensity, beam diameter, side lobe ratio, and efficiency for an additional phase factor of −0.032π×(m−1) (i.e., a second additional phase factor equal to −0.032π×(m−1)). Row 3 of Table 1 illustrates beam intensity, beam diameter, side lobe ratio, and efficiency for an additional phase factor of −0.044π×(m−1) (i.e., a third additional phase factor equal to −0.044π×(m−1)). Row 4 of Table 1 illustrates beam intensity, beam diameter, side lobe ratio, and efficiency for an additional phase factor of −0.1π×(m−1) (i.e., a fourth additional phase factor equal to −0.1π×(m−1).

FIG. 11B is a plot of beam intensity in a transverse/axial cross-section produced using the first additional phase factor (i.e., an additional phase factor of zero) according to an embodiment of the present invention. FIG. 11C is a plot of beam diameter as a function of axial position for the beam shown in FIG. 11B according to an embodiment of the present invention. As illustrated in FIG. 11B, the beam intensity is generally uniform as a function of the axial direction axis over a length of 1000 μm and has a peak intensity of 4400 A.U. The side lobe ratio is 1.4% and side lobes are not readily apparent in FIG. 11B. As illustrated in FIG. 11C, the beam diameter (FWHM) at a first end of the needle-shaped beam positioned at 18000 μm is ˜8 μm, the beam diameter increases to ˜14 μm at the center of the needle-shaped beam positioned at 18500 μm, and the beam diameter decreases to ˜8 μm at the second end of the needle-shaped beam positioned at 19000 μm. The efficiency is 12%.

FIG. 11D is a plot of beam intensity in a transverse/axial cross-section produced using the second additional phase factor (i.e., an additional phase factor of −0.032π×(m−1) according to an embodiment of the present invention. FIG. 11E is a plot of beam diameter as a function of axial position for the beam shown in FIG. 11D according to an embodiment of the present invention.

As illustrated in FIG. 11D, the beam intensity is generally uniform as a function of the axial direction over a length of 1000 μm and has a peak intensity of 9000 A.U. The side lobe ratio is 7% and faint side lobes are apparent in FIG. 11B. As illustrated in FIG. 11E, the beam diameter (FWHM) at a first end of the needle-shaped beam positioned at 18000 μm is ˜4.5 μm, the beam diameter increases to ˜10.5 μm at the center of the needle-shaped beam positioned at 18500 μm, and the beam diameter decreases to ˜4.5 μm at the second end of the needle-shaped beam positioned at 19000 μm. Thus, the use of this second additional phase factor increases the beam intensity and decreases the beam diameter in comparison to the use of the first additional phase factor. The efficiency is 13%.

FIG. 11F is a plot of beam intensity in a transverse/axial cross-section produced using the third additional phase factor (i.e., an additional phase factor of −0.044π×(m−1)) according to an embodiment of the present invention. FIG. 11G is a plot of beam diameter as a function of axial position for the beam shown in FIG. 11F according to an embodiment of the present invention.

As illustrated in FIG. 11F, the beam intensity is generally uniform as a function of the axial direction over a length of 1000 μm and has a peak intensity of 8500 A.U. The side lobe ratio is 12% and side lobes are apparent in FIG. 11F with an intensity in the first side lobe of ˜4000 A.U. As illustrated in FIG. 11G, the beam diameter (FWHM) at a first end of the needle-shaped beam positioned at 18000 μm is ˜4 μm, the beam diameter increases to ˜8.5 μm at the center of the needle-shaped beam positioned at 18500 μm, and the beam diameter decreases to ˜4 μm at the second end of the needle-shaped beam positioned at 19000 μm. Thus, the use of this third additional phase factor substantially maintains the beam intensity with respect to the use of the second additional phase factor and decreases the beam diameter slightly in comparison to the use of the second additional phase factor. These changes are accompanied by an increase in the side lobe ratio, increasing from 7% to 12% and a decrease in efficiency from 13% to 9% as the beam intensity in the side lobes increases.

FIG. 11H is a plot of beam intensity in a transverse/axial cross-section produced using the fourth additional phase factor (i.e., an additional phase factor of −0.01π×(m−1)) according to an embodiment of the present invention. FIG. 11I is a plot of beam diameter as a function of axial position for the beam shown in FIG. 11H according to an embodiment of the present invention.

As illustrated in FIG. 11H, the beam intensity is generally uniform as a function of the axial direction over a length of 1000 μm and has a peak intensity of 6700 A.U. The side lobe ratio is 15% and multiple side lobes are apparent in FIG. 11H with an intensity in the first side lobe of ˜4000 A.U. As illustrated in FIG. 11I, the beam diameter (FWHM) at a first end of the needle-shaped beam positioned at 18000 μm is −4 μm, the beam diameter increases to ˜5.5 μm at the center of the needle-shaped beam positioned at 18500 μm, and the beam diameter decreases to ˜4 μm at the second end of the needle-shaped beam positioned at 19000 μm. Thus, the use of this fourth additional phase factor results in a decrease in beam intensity with respect to the use of the second and third additional phase factors and decreases the beam diameter at the center of the beam in comparison to the use of the second and third additional phase factors. These changes are accompanied by an increase in the side lobe ratio, increasing to 15% and a decrease in efficiency to 2.4% as the beam intensity in the multiple side lobes increases.

Depending on the particular application, the additional phase factor can be adjusted to a predetermined value in order to achieve the desired combination of beam intensity, beam diameter, side lobe ratio, and efficiency for the needle-shaped beam. As will be evident to one of skill in the art, depending on the particular application, a higher beam intensity may be desired, whereas in other applications, a narrow beam waist may be desired at the expense of a higher side lobe ratio or lower efficiency. Thus, using embodiments of the present invention, a high degree of control is provided over the beam characteristics via control over the axial position of foci as a function of the index number of focus as well as the selection of the additional phase factor. Controlling these values, desired metrics for each of the beam intensity, the beam diameter, the side lobe ratio, and the efficiency of the needle-shaped beam can be achieved.

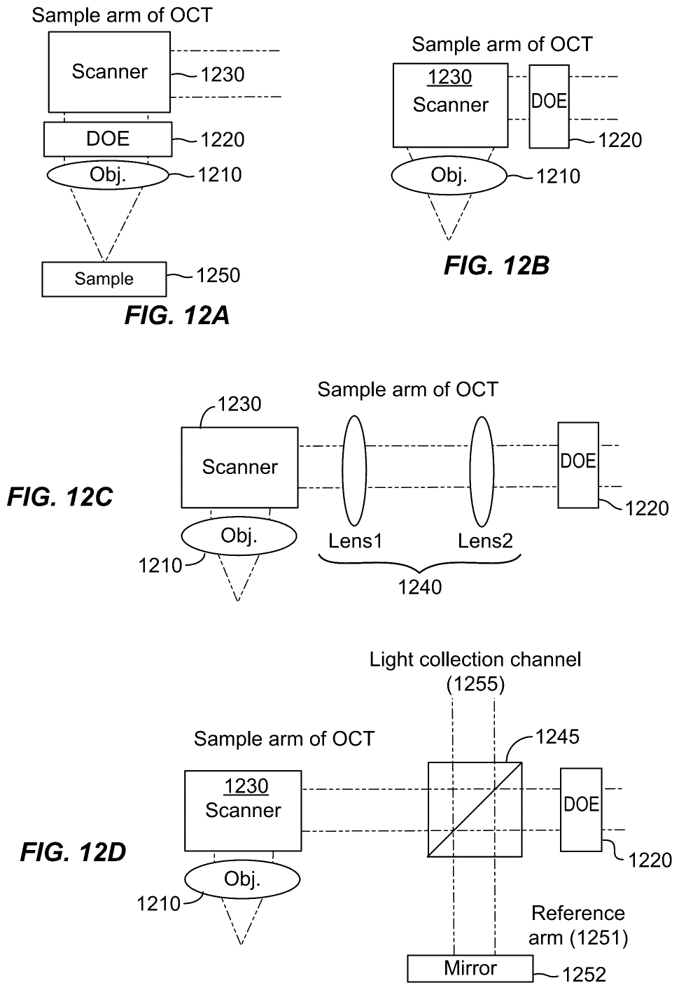

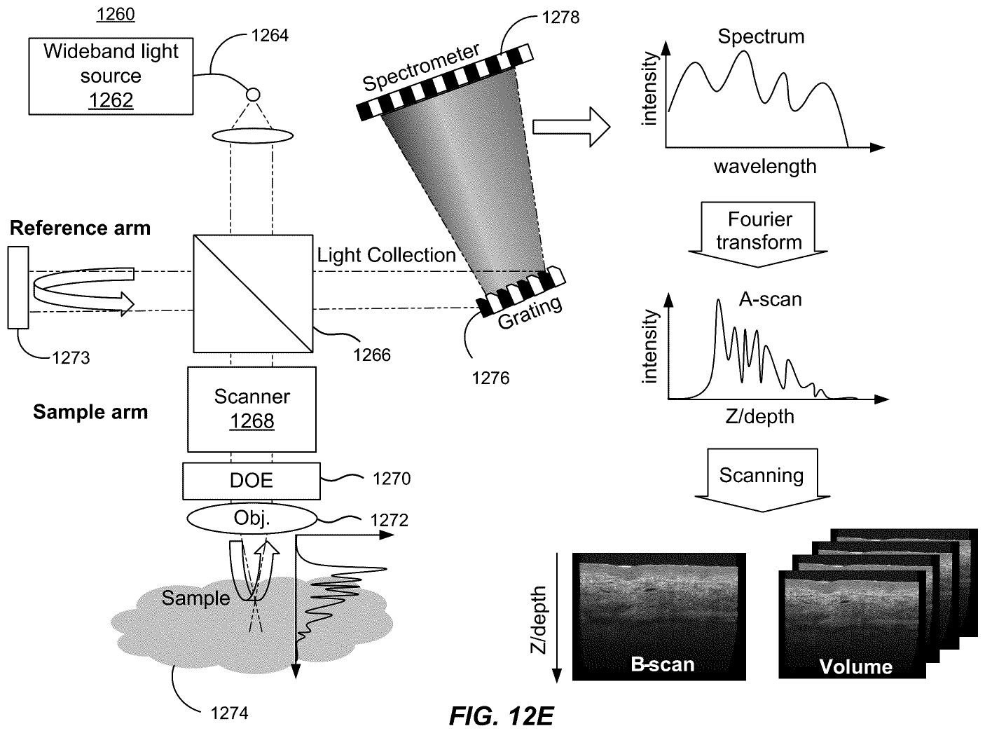

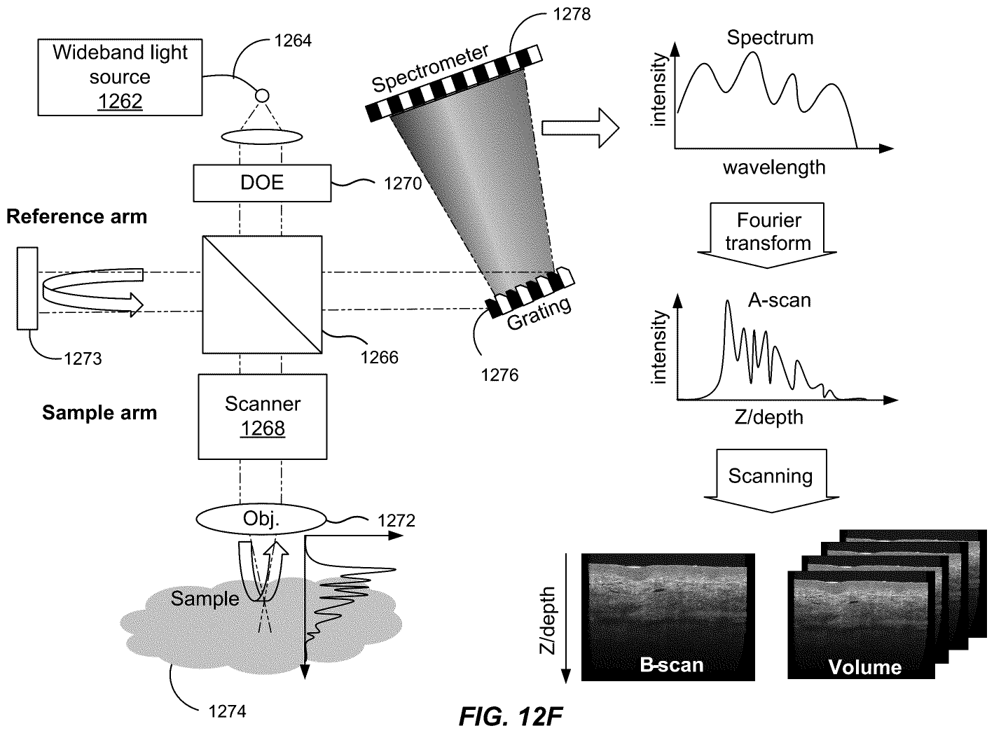

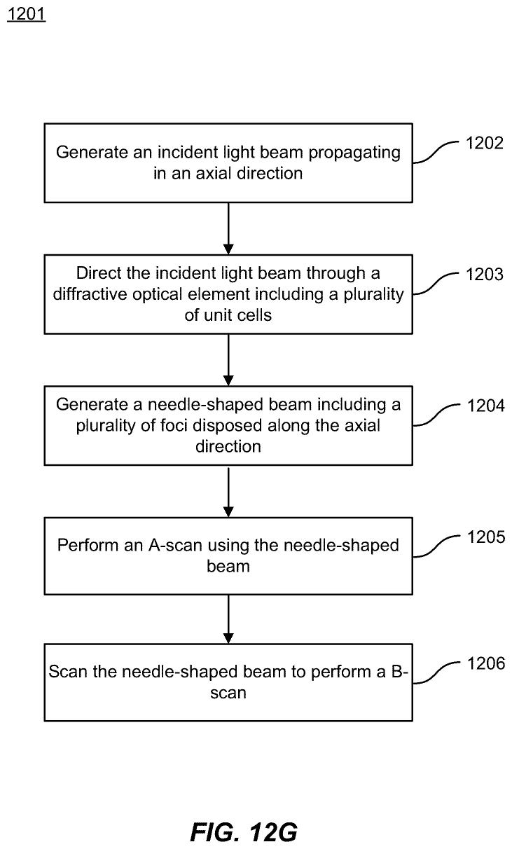

Several different OCT architectures can be used in conjunction with the phase modulation device described herein. FIGS. 12A-12D illustrate a few of these architectures. The OCT system can be a bench top system or an endoscopic system.

FIG. 12A is a simplified cross-sectional view of an OCT with an integrated DOE in the sample arm of the OCT according to an embodiment of the present invention. As shown in FIG. 12A, the DOE 1220 can be located adjacent objective lens 1210 such that DOE 1220 receives incident light from scanner 1230 prior to focusing onto the sample 1250 by objective lens 1210. This design, with DOE 1220 positioned between objective lens 1210 and scanner 1230, enables use of the needle-shaped beam with minimal changes to an OCT system.

FIG. 12B is a simplified cross-sectional view of an OCT with an integrated DOE in the sample arm of the OCT according to another embodiment of the present invention. In the architecture illustrated in FIG. 12B, DOE 1220 is installed in the optical path so that DOE 1220 receives incident light before reaching scanner 1230 and objective lens 1210.

FIG. 12C is a simplified cross-sectional view of an OCT with an integrated DOE in the sample arm of the OCT according to yet another embodiment of the present invention. In the architecture illustrated in FIG. 12C, a relay lens system 1240, also referred to as a 4f system, can be positioned between scanner 1230 and DOE 1220 to facilitate insertion of additional optical elements along the optical path between DOE 1220 and scanner 1230.

FIG. 12D is a simplified cross-sectional view of an OCT with an independent light collection channel 1255 and an integrated DOE in the sample arm of the OCT according to an embodiment of the present invention. By using a beam splitter cube 1245 and positioning DOE 1220 in the optical path so that DOE 1220 receives incident light before reaching beam splitter cube 1245, an independent light collection channel 1255 is utilized to enhance the collection efficiency. Reference arm 1251 and corresponding mirror 1252 are also illustrated in FIG. 12D.

FIG. 12E is a simplified schematic diagram illustrating elements of a spectral domain OCT system with an integrated DOE according to an embodiment of the present invention. A spectral domain OCT (SD-OCT) system is a noninvasive optical imaging system based on a spectral interferometer. For one A-scan (i.e., one shot), it can convert the spectrum using a Fourier transform into the sample profile along the depth. Cooperating with scanning mirrors, SD-OCT is able to capture B-scans and an image of the entire sample volume. The SD-OCT system 1260 includes a wideband light source 1262 coupled via a single mode fiber 1264. Light from wideband light source 1262 is incident on beam splitter 1266. In the embodiment illustrated in FIG. 12E, the sample arm includes scanner 1268, DOE 1270, and objective lens 1272. The reference arm utilizes mirror 1273. Light reflected from the sample 1274 is collected using grating 1276 and imaged using spectrometer 1278. The insets illustrate intensity vs. wavelength for the acquired spectrum and the A-scan intensity vs. depth along the axial axis. Scanning results in imaging of the entire sample volume.

Referring to FIGS. 12A-12C, any of the configurations shown in FIGS. 12A-12C can be utilized with the embodiment illustrated in FIG. 12E. In FIG. 12E, the configuration illustrated in FIG. 12A is utilized.

FIG. 12F is a simplified schematic diagram illustrating elements of an SD-OCT system with an integrated DOE according to another embodiment of the present invention. The SD-OCT system illustrated in FIG. 12F shares similar elements with the SD-OCT system illustrated in FIG. 12E and the description provided in relation to FIG. 12E is applicable to FIG. 12F as appropriate.

Referring to FIG. 12F, in this configuration, DOE 1270 is placed before beam splitter 1266 and the back-scattered light from sample 1274 does not pass through DOE 1270. In FIG. 12F, the configuration illustrated in FIG. 12D is utilized.

The SD-OCT systems illustrated in FIGS. 12E and 12F are merely exemplary and provided to demonstrate the basic principle of the utilization of DOEs in an OCT system and are not intended to limit the scope of the various embodiments of the present invention described herein. As will be evident to one of skill in the art, the particular implementation details will depend on the particular configuration and application. One of ordinary skill in the art would recognize many variations, modifications, and alternatives.

FIG. 12G is a simplified flowchart illustrating a method of collecting an optical coherence tomography (OCT) image according to an embodiment of the present invention. The method 1201 includes generating an incident light beam propagating in an axial direction (1202) and directing the incident light beam through a diffractive optical element (DOE) including a plurality of unit cells (1203). Each unit cell of the plurality of unit cells includes a plurality of phase elements and each of the plurality of phase elements is characterized by a different phase value.

In an embodiment, the different phase values are a set of N phase values and each of the different phase values is equal to an incremental phase value times an index m, wherein m=1 . . . N. As an example, the set of N phase values ranges between 0 radians and 2π radians and the incremental phase value can be equal to 2π/N. In another embodiment, the different phase values are distributed differently in at least two of the plurality of unit cells. Thus, a first unit cell can be characterized by a first distribution of a first phase value (e.g., a first number of values corresponding to a first foci f₁) and a second unit cell can be characterized by a second distribution of the phase value (e.g., a different number of values corresponding to the first foci f₁). In some embodiments, the different phase values are distributed randomly in the at least two of the plurality of unit cells.

The method also includes generating a needle-shaped beam including a plurality of foci disposed along the axial direction (1204), performing an A-scan using the needle-shaped beam (1205), and scanning the needle-shaped beam to perform a B-scan (1206). The needle-shaped beam is characterized by a depth of focus between 4 and 200 Rayleigh lengths, for example, between 5 and 100 Rayleigh lengths. In some embodiments, the plurality of unit cells form a two-dimensional array that is formed in the transverse/lateral plane.

In some embodiments, the method further includes focusing the incident light beam after the incident light beam has been directed through the diffractive optical element. Moreover, in other embodiments, the method additionally includes image relaying the incident light beam after the incident light beam has been directed through the diffractive optical element.

It should be appreciated that the specific steps illustrated in FIG. 12G provide a particular method of collecting an OCT image according to an embodiment of the present invention. Other sequences of steps may also be performed according to alternative embodiments. For example, alternative embodiments of the present invention may perform the steps outlined above in a different order. Moreover, the individual steps illustrated in FIG. 12G may include multiple sub-steps that may be performed in various sequences as appropriate to the individual step. Furthermore, additional steps may be added or removed depending on the particular applications. One of ordinary skill in the art would recognize many variations, modifications, and alternatives.

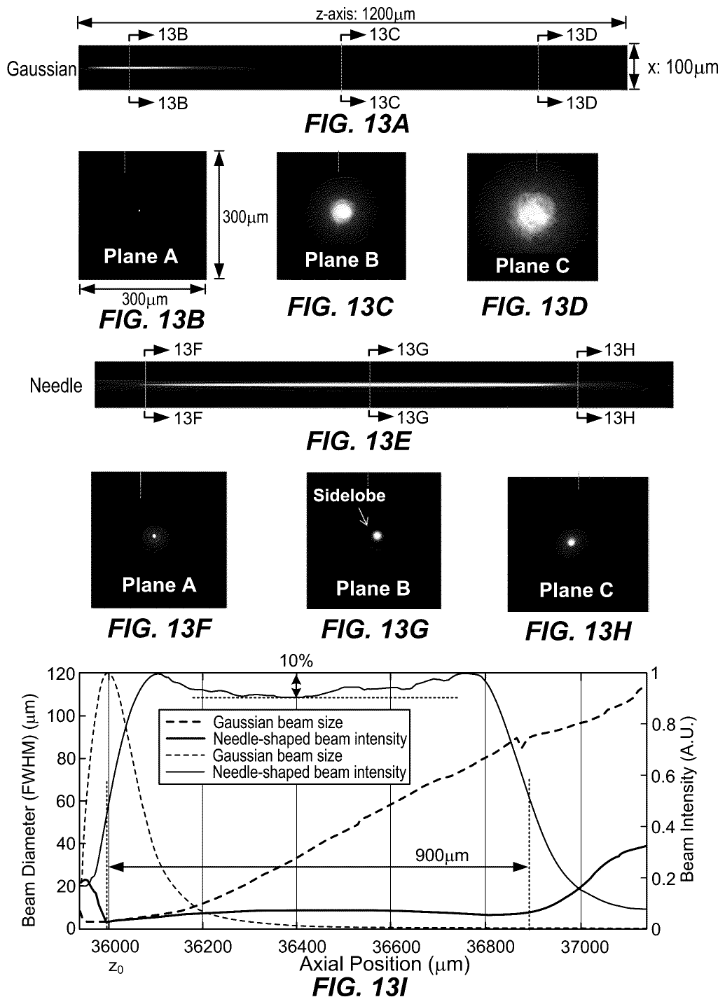

FIG. 13A is a simplified plot illustrating beam intensity as a function of axial position for a Gaussian beam. In this plot, the light source has a center wavelength of 900 nm and a bandwidth of 200 nm, the beam diameter is 4.6 mm, the objective lens has a focal length of 18 mm, and the beam intensity peaks at location z₀. FIG. 13B is a plot illustrating beam intensity in a transverse/lateral cross-section at a first axial position for the Gaussian beam. FIG. 13C is a plot illustrating beam intensity in a transverse/lateral cross-section at a second axial position for the Gaussian beam. FIG. 13D is a plot illustrating beam intensity in a transverse/lateral cross-section at a third axial position for the Gaussian beam. The depth of focus of the Gaussian beam is 36 μm (two-fold Rayleigh lengths) and the diameter increases to 60 μm at an axial position of 600 μm (FIG. 13C) and 90 μm at an axial position of 900 μm (FIG. 13D).

In contrast with the Gaussian beam, a needle-beam with 100 foci was generated and the depth of focus was extended to 900 μm (50-fold Rayleigh lengths). According to embodiments of the present invention, the depth of focus can range between 4 Rayleigh lengths and 200 Rayleigh lengths, for example, the depth of focus can be greater than 4 Rayleigh lengths, greater than 5 Rayleigh lengths, greater than 10 Rayleigh lengths, greater than 15 Rayleigh lengths, greater than 20 Rayleigh lengths, greater than 25 Rayleigh lengths, greater than 30 Rayleigh lengths, greater than 40 Rayleigh lengths, or greater than 50 Rayleigh lengths. For the beam characteristic measurements presented herein, a beam profiling camera (WinCamD available from DataRay of Redding, CA) was utilized.

FIG. 13E is a simplified plot illustrating beam intensity as a function of axial position for a needle-shaped beam according to an embodiment of the present invention. FIG. 13F is a plot illustrating beam intensity in a transverse/lateral cross-section at a first axial position for the needle-shaped beam. FIG. 13G is a plot illustrating beam intensity in a transverse/lateral cross-section at a second axial position for the needle-shaped beam. FIG. 13H is a plot illustrating beam intensity in a transverse/lateral cross-section at a third axial position for the needle-shaped beam.

As illustrated in FIGS. 13E-13H, the needle-shaped beam is characterized by a beam diameter of ˜4 μm-˜8.5 μm (FWHM) with an axial uniformity has a variation less than 10% along the axial extent of the needle-shaped beam and the maximum side lobe having less than 7% of the beam intensity of the center lobe. These images of the needle-shaped beam clearly indicate that the needle-shaped beam is well suited for extended depth of focus imaging applications including OCT imaging of in vivo specimens.

FIG. 13I is a plot illustrating beam size and beam intensity as a function of axial position for the Gaussian beam and the needle-shaped beam illustrated in FIGS. 13A and 13E, respectively. As illustrated in FIG. 13I, the beam diameter of the Gaussian is narrowest at location z₀, increasing as the beam propagates away from the beam waist. The Gaussian beam intensity peaks at the beam waist (location z₀) and decreases as the beam propagates away from the beam waist.

In contrast with the Gaussian beam, the needle-shaped beam provided by embodiments of the present invention maintains a substantially uniform beam diameter in the range of 4-8 μm over an axial distance of 900 μm. Moreover, the beam intensity is characterized by an axial uniformity better than 90% (i.e., variation less than 10%) over the axial distance of 900 μm.

In order to demonstrate the utility of the needle-shaped beam provided by embodiments of the present invention, a phase modulation device in the form of a DOE was directly inserted into the sample arm of a commercial OCT system (Ganymede™ OCTP-900 available from Thorlabs of Newton, NJ). The light source has a center wavelength of 900 nm and a bandwidth of 200 nm, the beam diameter is 4.6 mm, and the objective lens has a focal length of 18 mm. Imaging was performed at a center wavelength of 910 nm with a bandwidth of 200 nm and images of 1 μm polystyrene beads suspended in a gel were obtained.

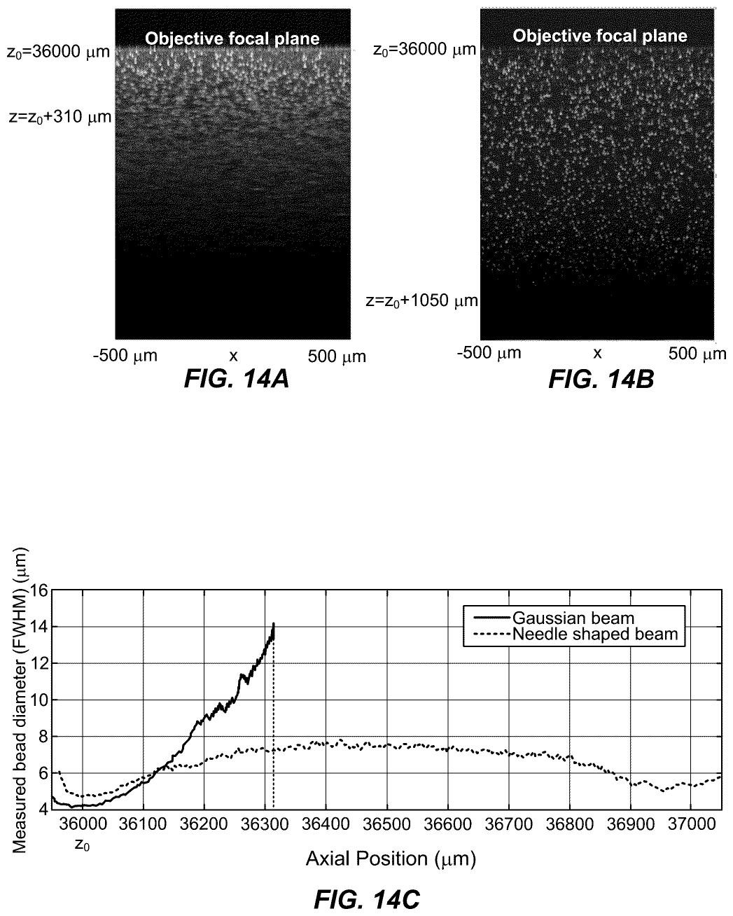

FIG. 14A is an OCT image showing polystyrene beads imaged using a Gaussian beam. FIG. 14B is an OCT image showing polystyrene beads imaged using a needle-shaped beam according to an embodiment of the present invention. Referring to FIGS. 14A and 14B, 1 μm polystyrene beads near the objective focal plane are illuminated by the Gaussian beam, however, the polystyrene beads located in the region farther than 310 μm from the objective focal plane (i.e., deeper in the sample than 310 μm) cannot be clearly visualized due to the deterioration in the transverse resolution and the decrease in signal-to-noise ratio. Using the Gaussian beam, the polystyrene bead size measured at a depth of 310 μm is 14 μm, which indicates that for depths greater than 310 μm, the individual polystyrene beads cannot be imaged using OCT imaging. In contrast, as shown in FIG. 14B, the needle-shaped beam provides clear imaging of the polystyrene beads to a depth of −1050 μm as a result of the needle-shaped beam having a substantially constant beam diameter as a function of axial position.

FIG. 14C is a plot illustrating measured bead diameter as a function of axial position for the measurements using the Gaussian beam and the needle-shaped beam, respectively. For the Gaussian beam, the measured bead diameter is ˜4 μm at the objective focal plane (location z₀), however, the measured bead size increases rapidly with measurement depth, reaching a bead diameter of 14 μm at a depth of 310 μm. As illustrated in FIG. 14C, the needle-shaped beam produces measured bead diameters of ˜7 μm across the entire measurement depth extending from z₀ to 1050 μm. Accordingly, embodiments of the present invention enable OCT imaging with a lateral resolution in the range of ˜4.5 μm-˜8 μm over a penetration depth of over 1000 μm with significantly enhanced contrast over this increased penetration depth.

The fact that both measurement techniques produced bead size measurements that were larger than the actual bead size of 1 μm indicates the resolution of both imaging techniques. Although the use of the Gaussian beam provides higher resolution (i.e., a resolution of 4 μm) near the objective focal plane, the resolution decreases rapidly with axial position, whereas the use of the needle-shaped beam enables a greatly expanded depth of focus while maintaining the resolution at ˜7 μm. Accordingly, as an example, if 10 μm diameter objects were located at a depth of 300 μm, this object would be measurable using the needle-shaped beam while it would not be measurable using the Gaussian beam since the resolution of the system using the Gaussian beam is greater than 12 μm at this depth.

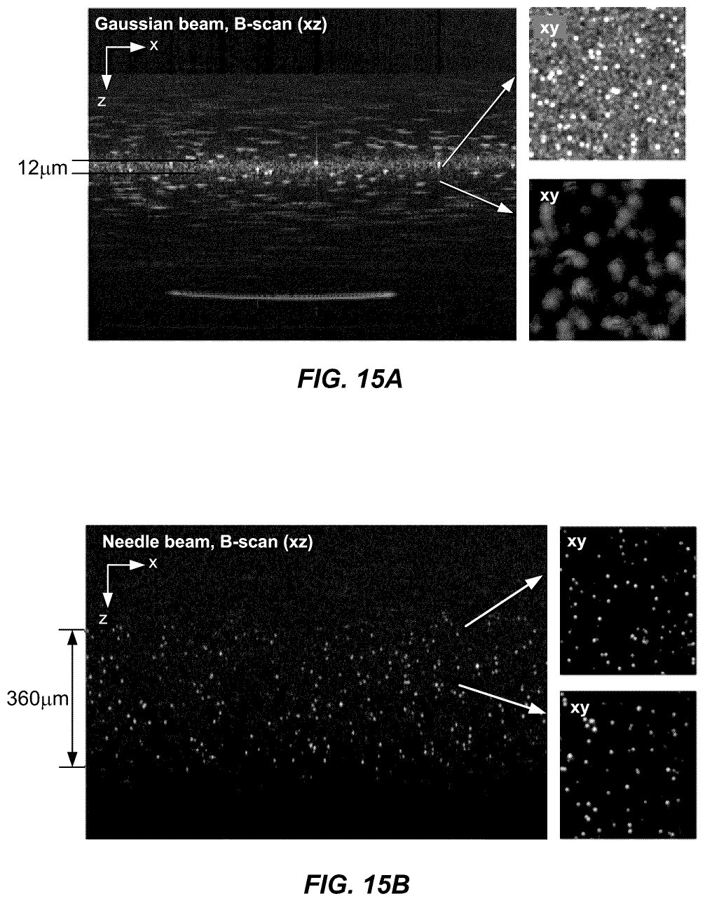

FIG. 15A is an OCT image showing polystyrene beads imaged using a Gaussian beam. FIG. 15B is an OCT image showing polystyrene beads imaged using a needle-shaped beam according to an embodiment of the present invention. In these images of 0.8 μm polystyrene beads, a comparison between OCT B-scans (in the transverse and axial directions) captured using a Gaussian beam and a needle-shaped beam is provided. In FIG. the OCT B-scan was captured using a Gaussian beam generated by a 20× water immersion lens (Olympus UMPLFLN 20XW available Edmund Optics of Barrington, NJ) with a focal length=9 mm, depth of focus=12 μm, and focal size=1.6 μm). In FIG. 15B, the OCT B-scan was captured using a needle-shaped beam generated by the DOE with a 20× water immersion lens. The DOE produced 121 foci with a depth of focus of 360 μm, a beam diameter of 3-4 μm, a side lobe ratio of 1.5%. As illustrated in FIGS. 15A and 15B, the needle-shaped beam provides a greatly enhanced depth of focus (i.e., an improvement by a factor of 30) in comparison to the use of the Gaussian beam while only reducing the resolution by a factor of ˜2, i.e., 1.6 μm compared to ˜3-4 μm.

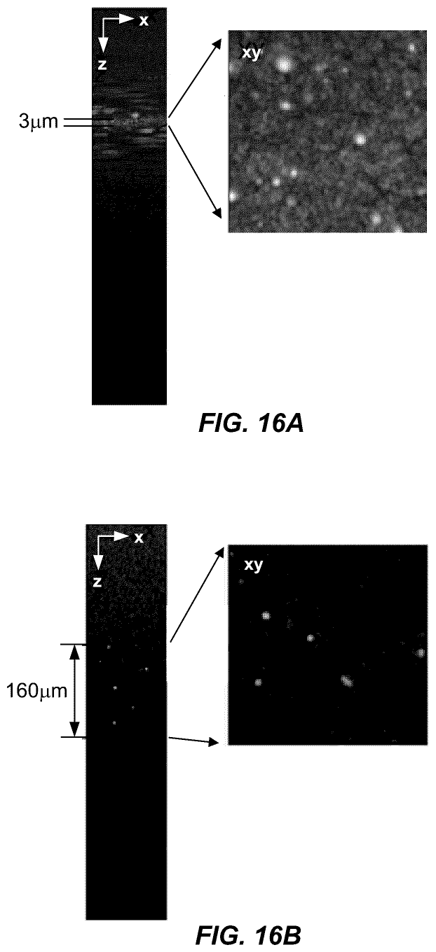

FIG. 16A is an OCT image showing 0.8 μm polystyrene beads imaged using a Gaussian beam. FIG. 16B is an OCT image showing 0.8 μm polystyrene beads imaged using a needle-shaped beam according to an embodiment of the present invention. In this comparison, the Gaussian beam was generated using 40× water immersion lens (Olympus UMPLFLN 40XW available Edmund Optics of Barrington, NJ), resulting in a focal length=4.5 mm, depth of focus of 3 μm, and focal size=1 μm). In comparison, as illustrated in FIG. 16B, the needle-shaped beam generated by the DOE using a 20× water immersion lens produced a beam with 225 foci, a depth of focus of 160 μm, and a consistent beam diameter of ˜1.5 μm to 2 μm.

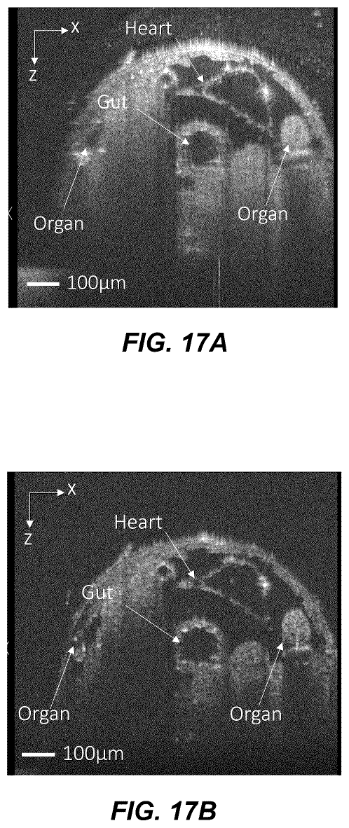

FIG. 17A is an OCT image showing a first biological sample imaged using a Gaussian beam. FIG. 17B is an OCT image showing the first biological sample imaged using the needle-shaped beam according to an embodiment of the present invention. In FIGS. 17A and 17B, the first biological sample is a live drosophila larva. The Gaussian beam used to capture the OCT image shown in FIG. 17A is generated by 10× objective (LSM02 objective available from Thorlabs) with a depth of focus of 36 μm and a focal size of 4 μm. The needle-shaped beam used to capture the OCT image shown in FIG. 17B is generated by a DOE using the 10× objective, utilizes 36 foci and provides a depth of focus of 600 μm and a beam diameter of ˜6 μm to 7 μm. As shown in FIG. 17B, using the needle-shaped beam, the outlines of the heart, the gut, and other organs can be clearly visualized and offer more accurate anatomical information than available using the Gaussian beam.

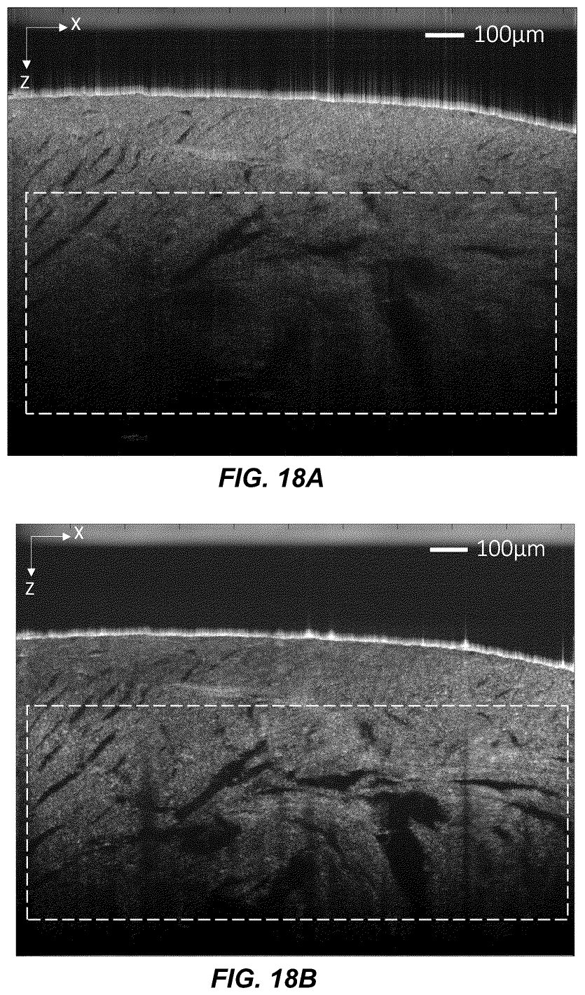

FIG. 18A is an OCT image showing a second biological sample imaged using a Gaussian beam. FIG. 18B is an OCT image showing the second biological sample imaged using a needle-shaped beam according to an embodiment of the present invention. In FIGS. 18A and 18B, the second biological sample is a cleared mouse heart. The Gaussian beam was generated using a 10× objective (LSM02 objective available from Thorlabs) with a depth of focus of 36 μm and a focal size of 4 μm. In contrast, the needle-shaped beam was generated by a DOE using the 10× objective, utilized 100 foci and provides a depth of focus of 1000 μm and a beam diameter of −4.5 μm to 8 μm. As shown in FIG. 18B, using the needle-shaped beam, images with a much deeper penetration depth and a high resolution in the imaged area are obtained compared to the images captured using the Gaussian beam.

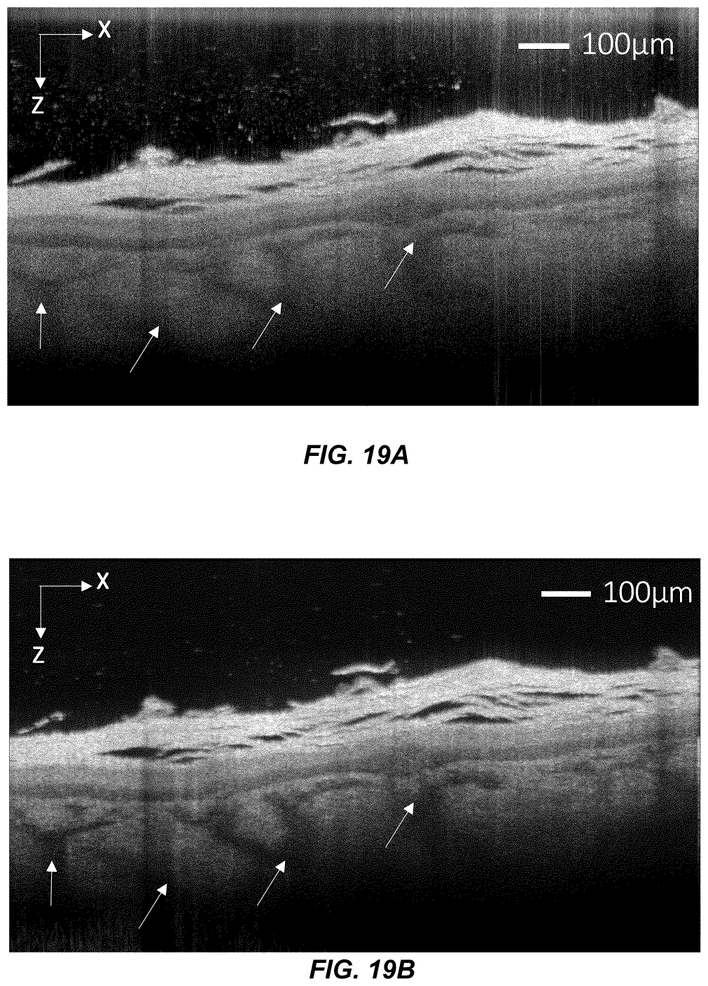

FIG. 19A is an OCT image showing human skin imaged using a Gaussian beam. FIG. 19B is an OCT image showing the human skin imaged using a needle-shaped beam according to an embodiment of the present invention. The Gaussian beam was generated using the 10× objective and had a depth of focus of 36 μm with a focal size of 4 μm. The needle-shaped beam was generated using a DOE using the 10× objective, utilized 64 foci and provides a depth of focus of 800 μm and a beam diameter of ˜6-8 μm. As shown in FIG. 19B, the resolution provided using the needle-shaped beam is higher than that available using the Gaussian beam.

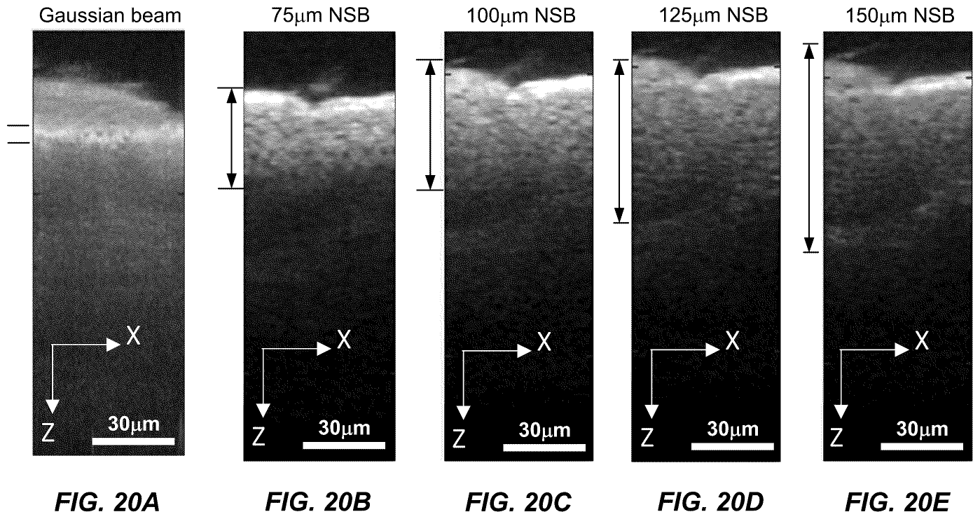

FIG. 20A is a first OCT image showing human skin imaged using a Gaussian beam. FIG. 20B is a second OCT image showing human skin imaged using a first needle beam according to an embodiment of the present invention. FIG. 20C is a third OCT image showing human skin imaged using a second needle beam according to an embodiment of the present invention. FIG. 20D is a fourth OCT image showing human skin imaged using a third needle beam according to an embodiment of the present invention. FIG. 20E is a fifth OCT image showing human skin imaged using a fourth needle beam according to an embodiment of the present invention. This series of figures compares OCT images captured using a Gaussian beam with images captured using four different needle-shaped beams generating using four different DOEs. Referring to FIG. 20A, the OCT image was captured using a Gaussian beam generated using the 40× water immersion lens with a focal length of 4.5 mm, had a depth of focus of 3 μm and a focal size of 1 μm. The four needle-shaped beams used to capture images shown in FIGS. 20B-20D were generated using four DOEs and the 20× water immersion lens. The lengths of the four needle-shaped beams were 75 μm, 100 μm, 125 μm, and 150 μm. The beam diameters were 1.4 μm, 1.6 μm, 1.8 μm, and 2 μm, respectively. The depths of focus for the needle-shaped beams are larger than that of Gaussian beam, enabling visualization of single cells in the epidermis using the needle-shaped beams provided by various embodiments of the present invention.

Although the exemplary needle-shaped beams discussed above have been characterized by uniform beam intensity as a function of the axial direction, this is not required by embodiments of the present invention. Rather, phase modulation devices including DOEs that provide a varying beam intensity as a function of the axial direction are included within the scope of the present invention. As described more fully below, if the interval between two adjacent foci is large, axial multi-foci beams can be generated. The energy distributed to each focus of the multiple foci can be controlled by the number of phase elements in the phase pattern assigned to this focus. Moreover, the additional phase factor can also be used to modulate the energy distribution between foci and the side lobes. In order to demonstrate beams with varying beam intensity, three examples are described below.

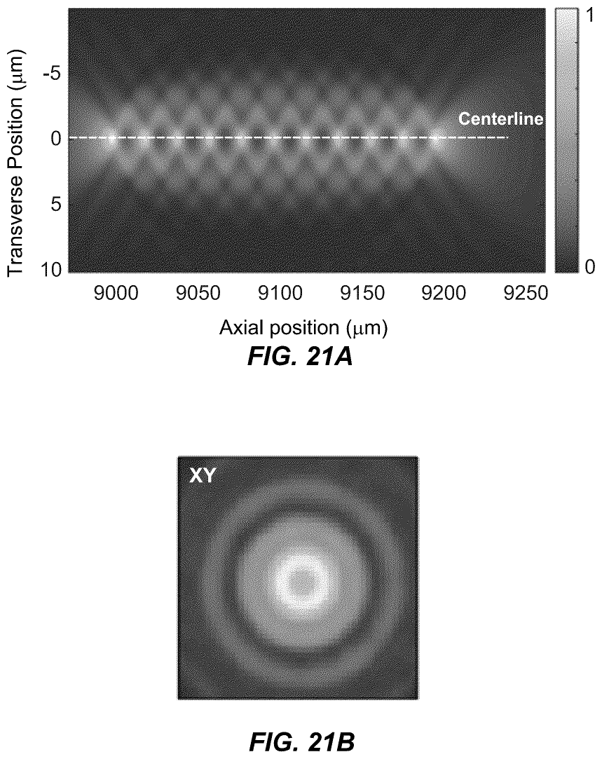

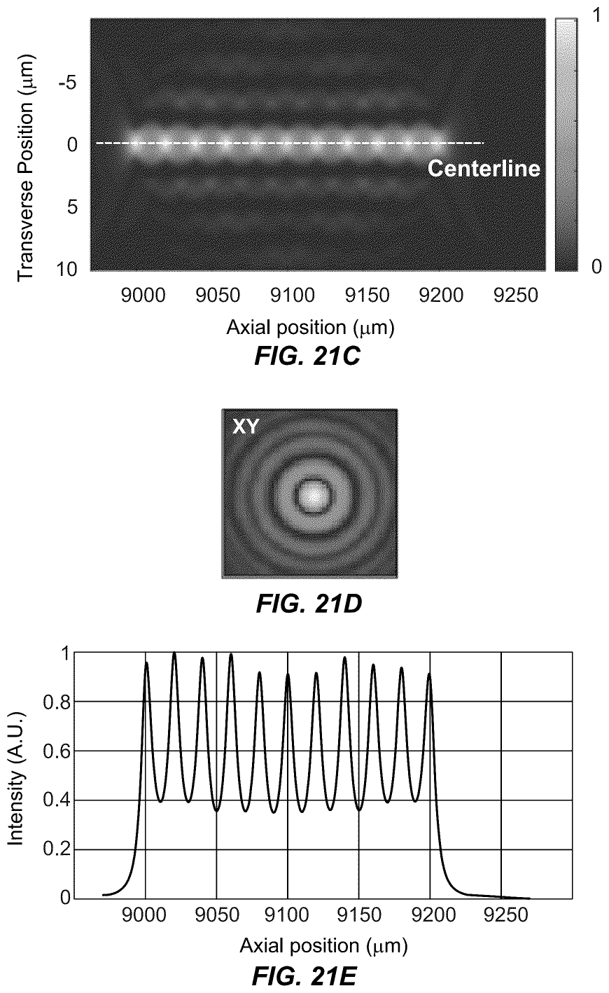

FIG. 21A is a plot of beam intensity in a transverse/axial cross-section produced using an alternative DOE and a first additional phase factor according to an embodiment of the present invention. Referring to FIG. 21A, a needle-shaped beam with 11 intensity peaks was generated using an objective with a focal length of 9 mm, the wavelength of the incident light beam was 910 nm, and the beam diameter was 4.6 mm. The interval between two adjacent foci is fixed at 25 μm and 11 foci are generated. Each unit cell contains a 20×20 array of phase elements. By optimizing the number of phase elements assigned to each focus of the 11 foci, the intensities of all the foci will be substantially constant as discussed in relation to FIG. 21E.

FIG. 21B is a plot illustrating beam intensity in a transverse/lateral cross-section at a specific axial position for the plot of beam intensity in FIG. 21A according to an embodiment of the present invention. Prior to optimization of the additional phase factor, the beam intensity of the main lobe at locations between the foci can be greater off-axis than on-axis, resulting in a ring profile in cross-section as illustrated in FIG. 21B.

FIG. 21C is a plot of beam intensity in a transverse/axial cross-section produced using an alternative DOE and a second additional phase factor according to an embodiment of the present invention. FIG. 21D is a plot illustrating beam intensity in a transverse/lateral cross-section at a specific axial position for the plot of beam intensity in FIG. 21C according to an embodiment of the present invention. By optimizing the additional phase factor Apₘ, the beam intensity of the main lobe at locations between the foci can be greater on-axis than off-axis, resulting in a circular profile in cross-section as illustrated in FIG. 21D. Moreover, as discussed herein, the beam intensity, beam diameter, efficiency, and side lobe ratio can also be controlled via optimization of the additional phase factor.

FIG. 21E is a plot of beam intensity as a function of axial position for the beam shown in FIG. 21C according to an embodiment of the present invention. As illustrated in FIG. 21E, 11 foci and accompanying peaks in the beam intensity are produced along the 2000 μm length of the needle-shaped beam.

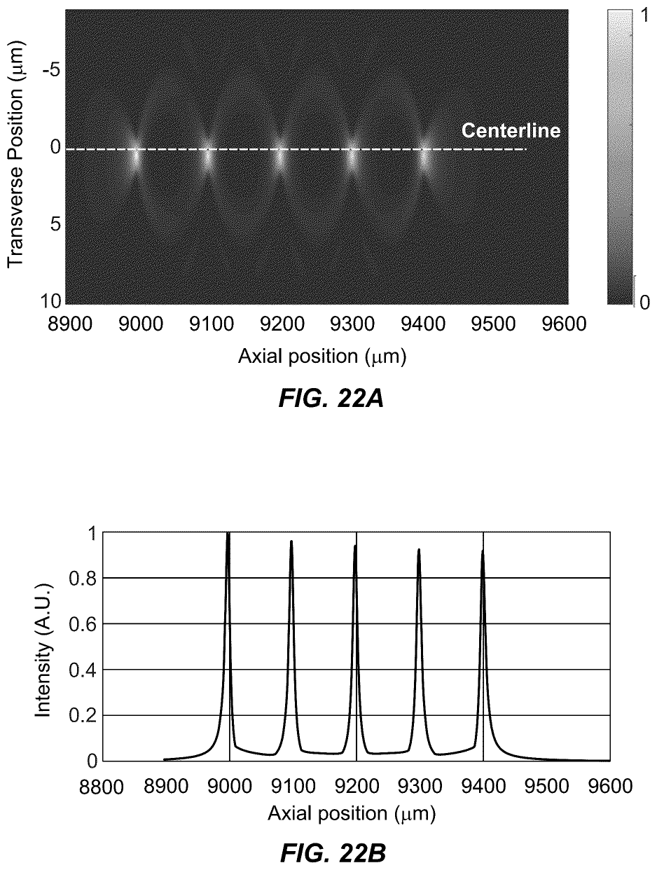

FIG. 22A is a plot of beam intensity in a transverse/axial cross-section produced using another alternative DOE according to an embodiment of the present invention. FIG. 22B is a plot of beam intensity as a function of axial position for the beam shown in FIG. 22A according to an embodiment of the present invention. To produce the needle-shaped beam with varying beam intensity as a function of axial position shown in FIG. 22A, an objective with a focal length of 9 mm was utilized, the wavelength of the incident light beam was 910 nm, and the beam diameter was 4.6 mm. As shown in FIG. 22B, the interval between two adjacent foci is fixed at 100 μm. In total, five foci are generated. Each unit cell contains a 5×5 array of phase elements. The phase elements of one unit cell are equally assigned to the five foci in this embodiment. In this case, the inventors have determined that since the interval between two adjacent foci is large, the additional phase factor Apₘ has little effect on the multi-foci beam and, as a result, the additional phase factor is not optimized in some implementations. As shown in FIG. 22B, a multi-foci beam is generated, with each focus having substantially the same beam intensity.

Comparing FIG. 21E to FIG. 22B, the beam intensity present between foci creates a baseline beam intensity of ˜0.4 A.U. in FIG. 21E that is missing in FIG. 22B, with the beam intensity between the five foci being substantially equal to zero.

FIG. 23A is a plot of beam intensity in a transverse/axial cross-section produced using yet another alternative DOE according to an embodiment of the present invention. FIG. 23B is a plot of beam intensity as a function of axial position for the beam shown in FIG. 23A according to an embodiment of the present invention. To produce this needle-shaped beam, which has an increasing intensity as a function of axial position, an objective with a focal length of 9 mm was utilized, the wavelength of the incident light beam was 910 nm, and the beam diameter was 4.6 mm. The interval between two adjacent foci was fixed at 100 μm.

As illustrated in FIGS. 23A and 23B, in total, five foci were generated. Each unit cell contains a 15×15 array of phase elements. The phase elements of each unit cell were assigned to the five foci using a ratio of 1:2:3:4:5 in order to generate different energies in each of the different foci. Accordingly, the beam intensity in each of the different foci increases as a function of propagation distance along the axial direction. In other embodiments, the beam intensity can decrease with propagation distance, with initial foci having higher intensities than more distant foci. One of ordinary skill in the art would recognize many variations, modifications, and alternatives.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A diffractive optical element comprising:
a substrate including a plurality of unit cells arrayed across the substrate, wherein each of the unit cells includes M phase elements and each of the M phase elements is characterized by one of a set of N phase values, wherein each of the set of N phase values is equal to an incremental phase value times an index m, wherein M>1 and m=1 . . . N.

2. The diffractive optical element of claim 1 wherein the incremental phase value is equal to 2π/N.

3. The diffractive optical element of claim 1 wherein 4<M<300.

4. The diffractive optical element of claim 3 wherein M>N.

5. The diffractive optical element of claim 1 wherein the substrate comprises fused silica.

6. The diffractive optical element of claim 1 wherein the set of N phase values are distributed differently in at least two of the plurality of unit cells.

7. The diffractive optical element of claim 1 wherein the set of N phase values are distributed randomly in the at least two of the plurality of unit cells.

8. The diffractive optical element of claim 1 wherein the plurality of unit cells form a two-dimensional array.

9. The diffractive optical element of claim 1 wherein each unit cell of the plurality of unit cells includes a predetermined number of phase elements characterized by the one of a set of N phase values.

10. A method of generating a needle-shaped beam, the method comprising:
providing a diffractive optical element including a plurality of unit cells, wherein each unit cell of the plurality of unit cells includes a plurality of phase elements and each of the plurality of phase elements is characterized by a different phase value;
receiving an incident beam of light propagating in an axial direction;
directing the incident beam of light to pass through the diffractive optical element; and
generating a plurality of foci along the axial direction to form the needle-shaped beam.

11. The method of claim 10 further comprising:
providing an objective lens; and
directing the incident beam of light to pass through the objective lens.

12. The method of claim 11 wherein the incident beam of light passes through the objective lens after the incident beam of light passes though the diffractive optical element.

13. The method of claim 10 wherein the needle-shaped beam is characterized by a depth of focus between 4 and 200 Rayleigh lengths.

14. The method of claim 13 wherein the depth of focus is between 5 and 100 Rayleigh lengths.

15. The method of claim 14 wherein the depth of focus is between 10 and 50 Rayleigh lengths.

16. The method of claim 10 wherein the different phase values comprise a set of N phase values and each of the different phase values is equal to an incremental phase value times an index m, wherein m=1 . . . N.

17. The method of claim 10 further comprising focusing the incident beam of light using a lens after the incident beam of light has passed through the diffractive optical element.

18. The method of claim 17 further comprising scanning the incident beam of light after the incident beam of light has passed through the diffractive optical element.

19. The method of claim 10 wherein the different phase values corresponding to each of the plurality of phase elements are distributed differently in at least two of the plurality of unit cells.

20. The method of claim 10 wherein the plurality of unit cells form a two-dimensional array.
